(19) United States
(12) Patent Application Publication
(10) Pub. No.: US 2026/0050073 A1
(43) Pub. Date: Feb. 19, 2026

(54) HYBRID FREQUENCY-MODULATED CONTINUOUS WAVE DESIGN FOR CELL SEARCH AND MEASUREMENT

(71) Applicant: QUALCOMM Incorporated, San Diego, CA (US)

(72) Inventors: Weimin DUAN, San Diego, CA (US); Kangqi LIU, San Diego, CA (US); Jing SUN, San Diego, CA (US)

(21) Appl. No.: 18/806,028

(22) Filed: Aug. 15, 2024

(51) Int. Cl. G01S 11/10; G01S 11/08

(52) U.S. Cl. CPC G01S 11/10; G01S 11/08

(57) ABSTRACT

Methods, systems, and devices for wireless communications are described. Generally, the described techniques enable a first wireless device to scramble at least a portion of one or more frequency-modulated continuous wave (FMCW) signals (e.g., hybrid FMCW signals) using a scrambling identifier, which may enable a second wireless device to differentiate between FMCW signals based on identifying the scrambling identifier. For example, the first wireless device may scramble at least a portion of an upchirp signal, a downchirp signal, or both, of an FMCW signal. The second wireless device may identify the scrambling identifier based on attempting to descramble the scrambled portion of the FMCW signal using multiple candidate scrambling identifiers. In some examples, a scrambling pattern (e.g., which portion of the upchirp signal, downchirp signal, or both, is scrambled) of a hybrid FMCW signal may indicate information associated with the first wireless device.

### FIELD OF TECHNOLOGY

The following relates to wireless communications, including hybrid frequency modulated continuous wave design for cell search and measurement.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, UEs may receive frequency-modulated continuous wave (FMCW) signals.

### SUMMARY

The systems, methods, and devices of this disclosure each have several innovative aspects, no single one of which is solely responsible for the desirable attributes disclosed herein.

A method for wireless communications by a user equipment (UE) is described. The method may include monitoring, over a bandwidth, for a frequency-modulated continuous wave (FMCW) signal associated with a cell, where the FMCW signal includes a first signal that increases in frequency from a first frequency to a second frequency in a time interval and a second signal that decreases in frequency from the second frequency to the first frequency in the time interval, and where at least a portion of the first signal, the second signal, or both, is scrambled in accordance with a scrambling identifier, identifying, based on the FMCW signal, the scrambling identifier from a set of multiple candidate scrambling identifiers, where the scrambling identifier is a function of cell information of the cell, and communicating one or more messages with the cell based on the cell information.

A UE for wireless communications is described. The UE may include one or more memories storing processor executable code, and one or more processors coupled with the one or more memories. The one or more processors may individually or collectively be operable to execute the code to cause the UE to monitor, over a bandwidth, for an FMCW signal associated with a cell, where the FMCW signal includes a first signal that increases in frequency from a first frequency to a second frequency in a time interval and a second signal that decreases in frequency from the second frequency to the first frequency in the time interval, and where at least a portion of the first signal, the second signal, or both, is scrambled in accordance with a scrambling identifier, identify, based at least in part on the FMCW signal, the scrambling identifier from a set of multiple candidate scrambling identifiers, where the scrambling identifier is a function of cell information of the cell, and communicate one or more messages with the cell based on the cell information.

Another UE for wireless communications is described. The UE may include means for monitoring, over a bandwidth, for an FMCW signal associated with a cell, where the FMCW signal includes a first signal that increases in frequency from a first frequency to a second frequency in a time interval and a second signal that decreases in frequency from the second frequency to the first frequency in the time interval, and where at least a portion of the first signal, the second signal, or both, is scrambled in accordance with a scrambling identifier, means for identifying, based on the FMCW signal, the scrambling identifier from a set of multiple candidate scrambling identifiers, where the scrambling identifier is a function of cell information of the cell, and means for communicating one or more messages with the cell based on the cell information.

A non-transitory computer-readable medium storing code for wireless communications is described. The code may include instructions executable by one or more processors to monitor, over a bandwidth, for an FMCW signal associated with a cell, where the FMCW signal includes a first signal that increases in frequency from a first frequency to a second frequency in a time interval and a second signal that decreases in frequency from the second frequency to the first frequency in the time interval, and where at least a portion of the first signal, the second signal, or both, is scrambled in accordance with a scrambling identifier, identify, based at least in part on the FMCW signal, the scrambling identifier from a set of multiple candidate scrambling identifiers, where the scrambling identifier is a function of cell information of the cell, and communicate one or more messages with the cell based on the cell information.

Some examples of the method, UEs, and non-transitory computer-readable medium described herein may further include operations, features, means, or instructions for receiving an FMCW burst transmission including the FMCW signal and at least a second FMCW signal, where the second FMCW signal includes a third signal that increases in frequency from a third frequency to a fourth frequency in a second time interval and a fourth signal that decreases in frequency from the fourth frequency to the third frequency in the second time interval. In some examples of the method, UEs, and non-transitory computer-readable medium described herein, a position of the FMCW signal in the FMCW burst transmission relative to the second FMCW signal indicates additional cell information of the cell. Some examples of the method, UEs, and non-transitory computer-readable medium described herein may further include operations, features, means, or instructions for receiving configuration information indicating a position of the FMCW signal in the FMCW burst transmission.

In some examples of the method, UEs, and non-transitory computer-readable medium described herein, the scrambling identifier may be identified based on the scrambling identifier descrambling at least the portion of the first signal, the second signal, or both, of the FMCW signal. Some examples of the method, UEs, and non-transitory computer-readable medium described herein may further include operations, features, means, or instructions for receiving configuration information indicating the set of multiple candidate scrambling identifiers, where each of the set of multiple candidate scrambling identifiers may be applied to the FMCW signal in accordance with the configuration information.

In some examples of the method, UEs, and non-transitory computer-readable medium described herein, a scrambling pattern or a location of the portion of the first signal, the second signal, or both, indicates additional cell information. In some examples of the method, UEs, and non-transitory computer-readable medium described herein, the scrambling identifier may be identified based on a default scrambling pattern at the UE.

Some examples of the method, UEs, and non-transitory computer-readable medium described herein may further include operations, features, means, or instructions for performing a cell search procedure within the bandwidth, where the FMCW signal may be communicated at a raster frequency of a set of multiple raster frequencies within the bandwidth and identifying a raster location and the raster frequency associated with the cell based on reception of the FMCW signal at the raster frequency, where the one or more messages may be communicated with the cell based on the raster frequency.

Some examples of the method, UEs, and non-transitory computer-readable medium described herein may further include operations, features, means, or instructions for performing a radio frequency sensing operation associated with the UE based on the FMCW signal and the scrambling identifier. Some examples of the method, UEs, and non-transitory computer-readable medium described herein may further include operations, features, means, or instructions for communicating information associated with a position of the UE based on the FMCW signal and the scrambling identifier.

In some examples of the method, UEs, and non-transitory computer-readable medium described herein, the cell information includes a cell identifier or a cell group identifier. In some examples of the method, UEs, and non-transitory computer-readable medium described herein, both the first signal and the second signal may be scrambled in accordance with the scrambling identifier. In some examples of the method, UEs, and non-transitory computer-readable medium described herein, the portion of the first signal, the second signal, or both, may be scrambled in a time domain, a frequency domain, or both.

A method for wireless communications by a network entity is described. The method may include outputting, over a bandwidth, an FMCW signal associated with a cell, the FMCW signal including a first signal that increases in frequency from a first frequency to a second frequency in a time interval and a second signal that decreases in frequency from the second frequency to the first frequency in the time interval, where at least a portion of the first signal, the second signal, or both, is scrambled in accordance with a scrambling identifier from a set of multiple candidate scrambling identifiers, and where the scrambling identifier is a function of cell information of the cell and communicating one or more messages with a UE based on the cell information.

A network entity for wireless communications is described. The network entity may include one or more memories storing processor executable code, and one or more processors coupled with the one or more memories. The one or more processors may individually or collectively be operable to execute the code to cause the network entity to output, over a bandwidth, an FMCW signal associated with a cell, the FMCW signal including a first signal that increases in frequency from a first frequency to a second frequency in a time interval and a second signal that decreases in frequency from the second frequency to the first frequency in the time interval, where at least a portion of the first signal, the second signal, or both, is scrambled in accordance with a scrambling identifier from a set of multiple candidate scrambling identifiers, and where the scrambling identifier is a function of cell information of the cell and communicate one or more messages with a UE based on the cell information.

Another network entity for wireless communications is described. The network entity may include means for outputting, over a bandwidth, an FMCW signal associated with a cell, the FMCW signal including a first signal that increases in frequency from a first frequency to a second frequency in a time interval and a second signal that decreases in frequency from the second frequency to the first frequency in the time interval, where at least a portion of the first signal, the second signal, or both, is scrambled in accordance with a scrambling identifier from a set of multiple candidate scrambling identifiers, and where the scrambling identifier is a function of cell information of the cell and means for communicating one or more messages with a UE based on the cell information.

A non-transitory computer-readable medium storing code for wireless communications is described. The code may include instructions executable by one or more processors to output, over a bandwidth, an FMCW signal associated with a cell, the FMCW signal including a first signal that increases in frequency from a first frequency to a second frequency in a time interval and a second signal that decreases in frequency from the second frequency to the first frequency in the time interval, where at least a portion of the first signal, the second signal, or both, is scrambled in accordance with a scrambling identifier from a set of multiple candidate scrambling identifiers, and where the scrambling identifier is a function of cell information of the cell and communicate one or more messages with a UE based on the cell information.

Some examples of the method, network entities, and non-transitory computer-readable medium described herein may further include operations, features, means, or instructions for outputting an FMCW burst transmission including the FMCW signal and at least a second FMCW signal, where the second FMCW signal includes a third signal that increases in frequency from a third frequency to a fourth frequency in a second time interval and a fourth signal that decreases in frequency from the fourth frequency to the third frequency in the second time interval. In some examples of the method, network entities, and non-transitory computer-readable medium described herein, a position of the FMCW signal in the FMCW burst transmission relative to the second FMCW signal indicates additional cell information of the cell. Some examples of the method, network entities, and non-transitory computer-readable medium described herein may further include operations, features, means, or instructions for obtaining configuration information indicating a position of the FMCW signal in the FMCW burst transmission.

Some examples of the method, network entities, and non-transitory computer-readable medium described herein may further include operations, features, means, or instructions for obtaining configuration information indicating the set of multiple candidate scrambling identifiers, where the portion of the first signal, the second signal, or both, may be scrambled in accordance with the configuration information.

In some examples of the method, network entities, and non-transitory computer-readable medium described herein, a scrambling pattern or a location of the portion of the first signal, the second signal, or both, indicates additional cell information of the cell. Some examples of the method, network entities, and non-transitory computer-readable medium described herein may further include operations, features, means, or instructions for obtaining configuration information indicating a scrambling pattern or a position of the portion of the first signal, the second signal, or both, where the portion of the first signal, the second signal, or both, may be scrambled based on the configuration information. In some examples of the method, network entities, and non-transitory computer-readable medium described herein, the FMCW signal may be output at a raster frequency of a set of multiple raster frequencies within the bandwidth and the one or more messages may be communicated with the UE based on the raster frequency.

Some examples of the method, network entities, and non-transitory computer-readable medium described herein may further include operations, features, means, or instructions for scrambling the portion of the first signal, the second signal, or both, in a time domain, a frequency domain, or both. In some examples of the method, network entities, and non-transitory computer-readable medium described herein, the cell information includes a cell identifier or a cell group identifier. In some examples of the method, network entities, and non-transitory computer-readable medium described herein, both the first signal and the second signal may be scrambled in accordance with the scrambling identifier.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support hybrid frequency-modulated continuous wave (FMCW) design for cell search and measurement in accordance with one or more aspects of the present disclosure.

FIG. 3 shows an example of a receiver process that supports hybrid FMCW design for cell search and measurement in accordance with one or more aspects of the present disclosure.

FIGS. 4A and 4B show examples of FMCW scrambling schemes that support hybrid FMCW design for cell search and measurement in accordance with one or more aspects of the present disclosure.

FIG. 5 shows an example of a process flow that supports hybrid FMCW design for cell search and measurement in accordance with one or more aspects of the present disclosure.

FIGS. 6 and 7 show block diagrams of devices that support hybrid FMCW design for cell search and measurement in accordance with one or more aspects of the present disclosure.

FIG. 8 shows a block diagram of a communications manager that supports hybrid FMCW design for cell search and measurement in accordance with one or more aspects of the present disclosure.

FIG. 9 shows a diagram of a system including a device that supports hybrid FMCW design for cell search and measurement in accordance with one or more aspects of the present disclosure.

FIGS. 10 and 11 show block diagrams of devices that support hybrid FMCW design for cell search and measurement in accordance with one or more aspects of the present disclosure.

FIG. 12 shows a block diagram of a communications manager that supports hybrid FMCW design for cell search and measurement in accordance with one or more aspects of the present disclosure.

FIG. 13 shows a diagram of a system including a device that supports hybrid FMCW design for cell search and measurement in accordance with one or more aspects of the present disclosure.

FIGS. 14 through 16 show flowcharts illustrating methods that support hybrid FMCW design for cell search and measurement in accordance with one or more aspects of the present disclosure.

### DETAILED DESCRIPTION

In some wireless communications systems, wireless devices, such as network entities or user equipment (UEs), may use frequency-modulated continuous wave (FMCW) signals for one or more purposes (e.g., cell search, sensing, positioning, communications). In some examples, the FMCW signals may be X-FMCW signals that include an upchirp signal (e.g., a signal increasing from a lowest frequency of the X-FMCW to a highest frequency of the X-FMCW in a time interval) and a downchirp signal (e.g., a signal decreasing from the highest frequency of the X-FMCW to the lowest frequency of the X-FMCW in the same time interval). However, in some wireless communications systems, the coexistence of multiple wireless devices transmitting FMCW signals in congested traffic (e.g., based on increasing quantity of devices transmitting FMCW signals for sensing, communications, or both) may negatively affect communications. For example, interference caused by other wireless devices transmitting FMCW signals may affect a sensing and detection capability of a UE for receiving one or more FMCW signals. That is, the UE may be unable to differentiate between FMCW signals transmitted to the UE and FMCW signals transmitted to other nearby UEs, thereby negatively affecting communications.

The techniques described herein support a network entity to scramble at least a portion of one or more X-FMCW signals (e.g., hybrid X-FMCW signals) using a scrambling identifier, which may enable a UE to differentiate between hybrid X-FMCW signals based on identifying the scrambling identifier. For example, the network entity may scramble at least a portion of the upchirp signal, the downchirp signal, or both, of a respective X-FMCW signal. In some examples, the network entity may transmit a burst of X-FMCW signals (e.g., two or more X-FMCW signals within a threshold duration). In such examples, the network entity may scramble at least a portion of one of the X-FMCW signals in the X-FMCW signal burst. Based on receiving a respective X-FMCW signal, the UE may identify the scrambling identifier based on attempting to descramble the scrambled portion of the respective X-FMCW signal using multiple candidate scrambling identifiers. In some examples, a scrambling pattern (e.g., which portion of the upchirp signal, downchirp signal, or both, is scrambled) of a respective hybrid X-FMCW signal may indicate information associated with the network entity. For example, the scrambling identifier may indicate a cell identifier (ID) or group cell ID of the network entity. Additionally, or alternatively, a position of a hybrid X-FMCW signal among the X-FMCW burst may indicate information associated with the network entity.

Aspects of the disclosure are initially described in the context of wireless communications systems. Aspects of the disclosure are then illustrated by and described herein with reference to a receiver process, FMCW scrambling schemes, and a process flow. Aspects of the disclosure are further illustrated by and described herein with reference to apparatus diagrams, system diagrams, and flowcharts that relate to hybrid FMCW design for cell search and measurement.

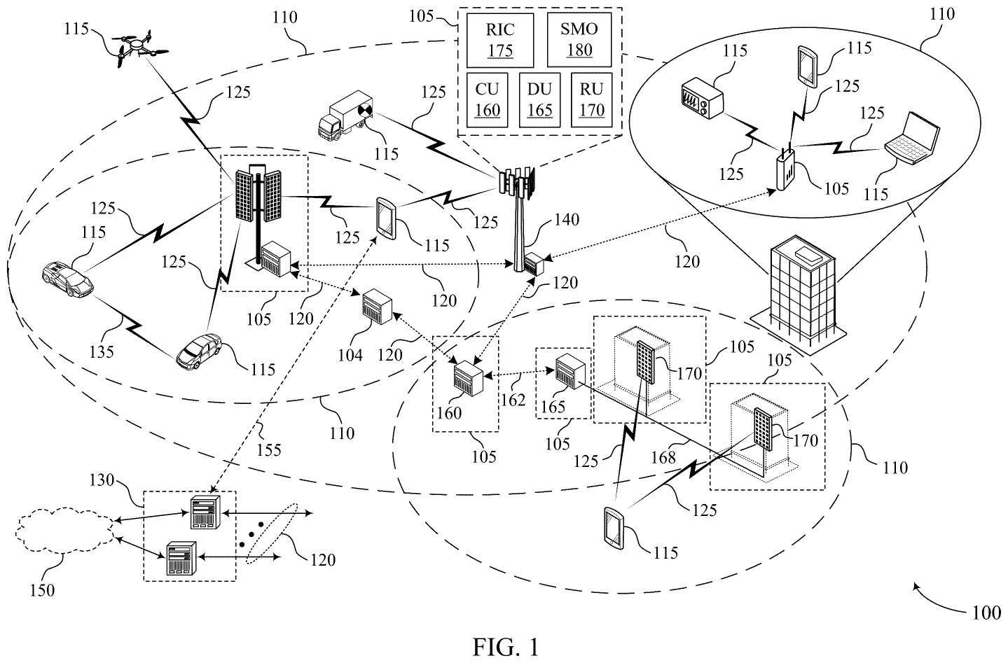

FIG. 1 shows an example of a wireless communications system 100 that supports hybrid FMCW design for cell search and measurement in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a geographic coverage area 110 over which the UEs 115 and the network entity 105 may establish the communication link(s) 125. The geographic coverage area 110 may be an example of a geographic area over which a network entity 105 and a UE 115 may support the communication of signals according to one or more radio access technologies (RATs).

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving geographic coverage area, such as the geographic coverage area 110. In some examples, geographic coverage areas 110 (e.g., different geographic coverage areas) associated with different technologies may overlap, but the geographic coverage areas 110 (e.g., different geographic coverage areas) may be supported by the same network entity (e.g., a network entity 105). In some other examples, overlapping geographic coverage areas, such as a geographic coverage area 110, associated with different technologies may be supported by different network entities (e.g., the network entities 105). The wireless communications system 100 may include, for example, a heterogeneous network in which different types of the network entities 105 support communications for geographic coverage areas 110 (e.g., different geographic coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the geographic coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the geographic coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some wireless communications systems, wireless devices, such as network entities 105 or UEs 115, may use FMCW signals for one or more purposes (e.g., cell search, sensing, positioning, communications). In some examples, the FMCW signals may be X-FMCW signals that include an upchirp signal (e.g., a signal increasing from a lowest frequency of the X-FMCW to a highest frequency of the X-FMCW in a time interval) and a downchirp signal (e.g., a signal decreasing from the highest frequency of the X-FMCW to the lowest frequency of the X-FMCW in the same time interval). However, in some wireless communications systems, the coexistence of multiple wireless devices transmitting FMCW signals in congested traffic (e.g., based on increasing quantity of devices transmitting FMCW signals for sensing, communications, or both) may negatively affect communications. For example, interference caused by other wireless devices transmitting FMCW signals may affect a sensing and detection capability of a UE 115 for receiving one or more FMCW signals. That is, the UE 115 may be unable to differentiate between FMCW signals transmitted to the UE 115 and FMCW signals transmitted to other nearby UEs 115, thereby negatively affecting communications.

The techniques described herein support a network entity 105 to scramble at least a portion of one or more X-FMCW signals (e.g., hybrid X-FMCW signals) using a scrambling identifier, which may enable a UE 115 to differentiate between hybrid X-FMCW signals based on identifying the scrambling identifier. For example, the network entity 105 may scramble at least a portion of the upchirp signal, the downchirp signal, or both, of a respective X-FMCW signal. In some examples, the network entity 105 may transmit a burst of X-FMCW signals (e.g., two or more X-FMCW signals within a threshold duration). In such examples, the network entity 105 may scramble at least a portion of one of the X-FMCW signals in the X-FMCW signal burst. Based on receiving a respective X-FMCW signal, the UE 115 may identify the scrambling identifier based on attempting to descramble the scrambled portion of the respective X-FMCW signal using multiple candidate scrambling identifiers. In some examples, a scrambling pattern (e.g., which portion of the upchirp signal, downchirp signal, or both, is scrambled) of a respective hybrid X-FMCW signal may indicate information associated with the network entity 105. For example, the scrambling identifier may indicate a cell ID or group cell ID of the network entity 105. Additionally, or alternatively, a position of a hybrid X-FMCW signal among the X-FMCW burst may indicate information associated with the network entity 105.

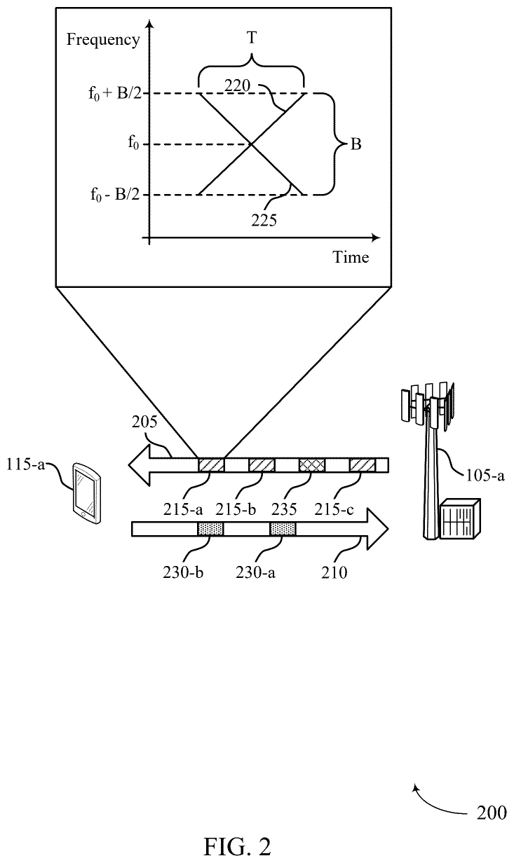

FIG. 2 shows an example of a wireless communications system 200 that supports hybrid FMCW design for cell search and measurement in accordance with one or more aspects of the present disclosure. The wireless communications system 200 may implement aspects of or may be implemented by aspects of the wireless communications system 100. For example, the wireless communications system 200 includes a network entity 105-a and a UE 115-a, which may be examples of corresponding devices as described herein, including with reference to FIG. 1. In some examples, the UE 115-a may receive one or more downlink transmissions 205, transmit one or more uplink transmissions 210, or both.

In some examples, the one or more downlink transmissions 205 may include one or more X-FMCW signals 215. An X-FMCW signal 215 may differ from an FMCW signal in that an X-FMCW signal 215 may use an overlaying of two FMCWs. That is, as described herein, an X-FMCW signal 215 may include a first signal 220 (e.g., an upchirp or upchirp signal) that increases in frequency from a lowest frequency of the X-FMCW signal 215 to a highest frequency of the X-FMCW and a second signal 225 (e.g., a down chirp or downchirp signal) that decreases in frequency from the highest frequency of the X-FMCW signal to the lowest frequency of the X-FMCW signal. The first signal 220 and the second signal 225 may have the same (e.g., or similar) slopes (e.g., a same up-sweep ramp and down-sweep ramp), and may form an “X” when overlaid, thus forming an “X-FMCW.” In some examples, the center of the cross may be referred to as the center frequency, f₀ (e.g., the sync raster point for the network entity 105-a). In such examples, the lowest frequency and the highest frequency of the X-FMCW signal may be based on a bandwidth, B, of the X-FMCW signal 215. For example, the lowest frequency may be f₀−B/2, and the highest frequency may be

$${f}_{0} - \frac{B}{2} .$$

In some examples, the network entity 105-a may generate an X-FMCW signal 215 using an OFDM architecture.

In some examples, an X-FMCW signal 215 may span a duration, T, in the time domain. For example, a respective X-FMCW signal 215 may span a duration equal to one OFDM symbol duration. In some other examples, an X-FMCW signal 215 may span a duration equal to multiple OFDM symbol durations (e.g., two or more OFDM symbols). In some examples, the network entity 105-a may use an X-FMCW signal 215 as a primary synchronization signal (PSS) for the UE 115-a. That is, the duration, T, and a bandwidth, B, of an X-FMCW signal 215 may be similar to that of a non-X-FMCW signal PSS.

Some wireless communications systems may utilize FMCW signals and/or X-FMCW signals 215 to perform a cell search procedure (e.g., via transmitting pre-synchronization signal block (SSB) FMCW signals). For example, a network entity 105 may transmit an X-FMCW signal 215 such that the center frequency, f₀, of the X-FMCW signal 215 is a synchronization raster point. X-FMCW signals 215 may enable a UE 115 to sweep a relatively large bandwidth (e.g., multiple subbands) over a relatively large duration to detect the time and frequency location of the synchronization raster point. Additionally, X-FMCW signals 215 may enable a UE 115 to perform relatively fewer fast Fourier transforms (FFTs) compared to non-FMCW signals for a cell search procedure because the UE 115 may perform one FFT for the large bandwidth sweep rather than multiple FFTs for multiple subband sweeps (e.g., the UE 115 may search one large frequency and time window rather than multiple small frequency and time windows).

However, multiple network entities 105 transmitting X-FMCW signals 215 in a same area (e.g., in a same geographic coverage area 110) may result in the X-FMCW signals 215 interfering with each other, which may degrade sensing and detection performance at the UE 115. For example, two network entities 105 (not shown) transmitting two FMCW signals using a same, or similar, slope for each of the upchirp and downchirp signals may result in interference for each of the X-FMCW signals 215, and a UE 115 may mistake one X-FMCW signal as being transmitted by the other network entity 105 (e.g., interfering X-FMCW signals 215 may result in a “false alarm” or spoofed reception at the UE 115). In some examples, different (e.g., dissimilar) slopes may still result in interference. In other words, the UE 115 may be unable to differentiate between X-FMCW signals 215 transmitted by different network entities 105.

Additionally, in some cases, one or more network entities 105 may transmit one or more X-FMCW signals 215 for procedures other than cell search. For example, the network entity 105-a may transmit X-FMCW signals 215 for RF sensing, UE positioning, beam management, or radio resource management (RRM), among other examples. In such cases, X-FMCW signals 215 transmitted by other network entities 105 (e.g., other than network entity 105-a) may interfere with the X-FMCW signals 215 transmitted by the network entity 105-a. For example, a UE 115 may receive an X-FMCW signal 215 transmitted by another network entity 105 for one procedure (e.g., an X-FMCW signal 215 for cell search) and may mistake the information in that X-FMCW signal 215 as information for a different procedure (e.g., beam management). That is, a pre-SSB FMCW signal may spoof an X-FMCW signal 215 for another procedure (e.g., sensing/positioning), or vice versa.

Some other wireless communications systems may apply time domain or frequency domain scrambling on pre-SSB X-FMCW signals 215 to embed additional cell-specific information, such as a cell group ID, to mitigate interference between FMCW signals. Encoding an FMCW signal may enable a UE 115 to determine which network entity 105 transmitted which FMCW signal. However, scrambling an entire FMCW signal may reduce the dynamic range (e.g., peak-to-sidelobe level) of a respective pre-SSB X-FMCW signal 215. In other words, there may be a trade-off between interference mitigation and sidelobe magnitude (e.g., a longer scrambling sequence may achieve stronger interference mitigation but may also create larger sidelobes).

In some examples, the longer the code length (e.g., the longer the scrambling code applied) per chirp, the higher the sidelobes of a respective scrambled FMCW signal. That is, longer scramble codes (e.g., 512 bits) may result in a more reduced dynamic range compared to shorter scramble codes (e.g., 8, 16, 64 bits). A reduced dynamic range may reduce detection performance at the UE 115. That is, a reduced dynamic range may result in less pronounced signal peaks. The UE 115 may identify the cell-specific information based on identifying one or more signal peaks, and, accordingly, less pronounced signal peaks may degrade detection performance.

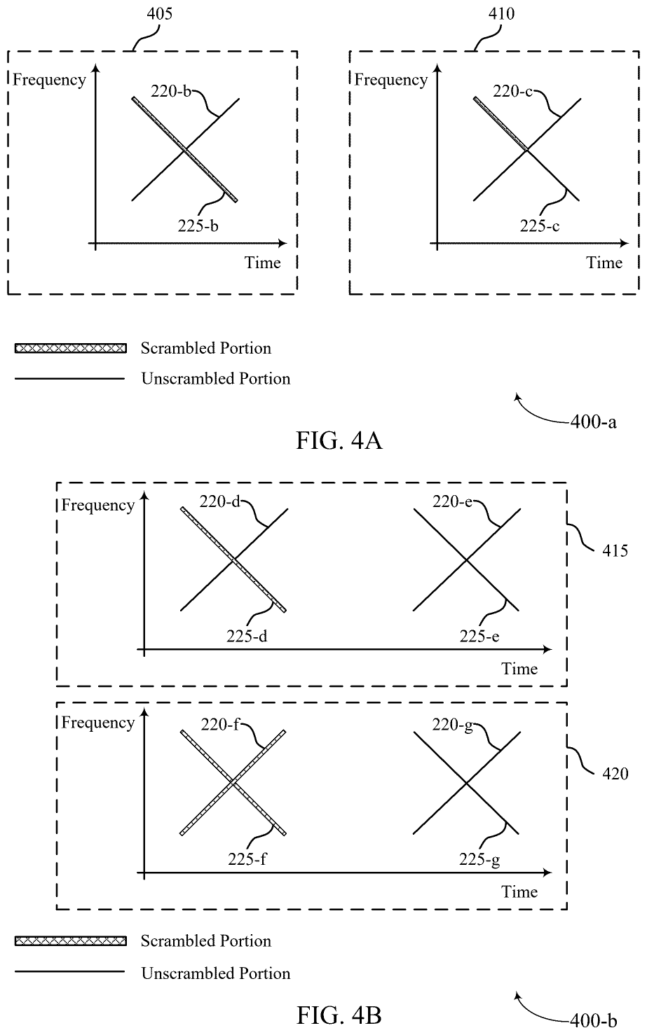

The techniques described herein enable the UE 115-a to monitor for, and receive, hybrid X-FMCW signals 215. That is, the network entity 105-a may scramble at least a portion of an X-FMCW signal 215 to provide interference mitigation and dynamic range. As described further herein with reference to FIG. 4A, the network entity 105-a may scramble at least a portion of the first signal 220, at least a portion of the second signal 225, or both. For example, the UE 115-a may receive a first hybrid X-FMCW signal 215-a where the first signal 220 is scrambled in accordance with a scrambling ID. Additionally, or alternatively, the UE 115-a may receive a burst of X-FMCW signals 215. For example, the UE 115-a may receive the first hybrid X-FMCW signal 215-a and a second hybrid X-FMCW signal 215-b as part of a burst transmission. As described further herein with reference to FIG. 4B, the network entity 105-a may scramble at least one X-FMCW signal 215 in the burst transmission. The network entity 105-a may scramble the hybrid X-FMCW signals 215 in the time domain, frequency domain, or both.

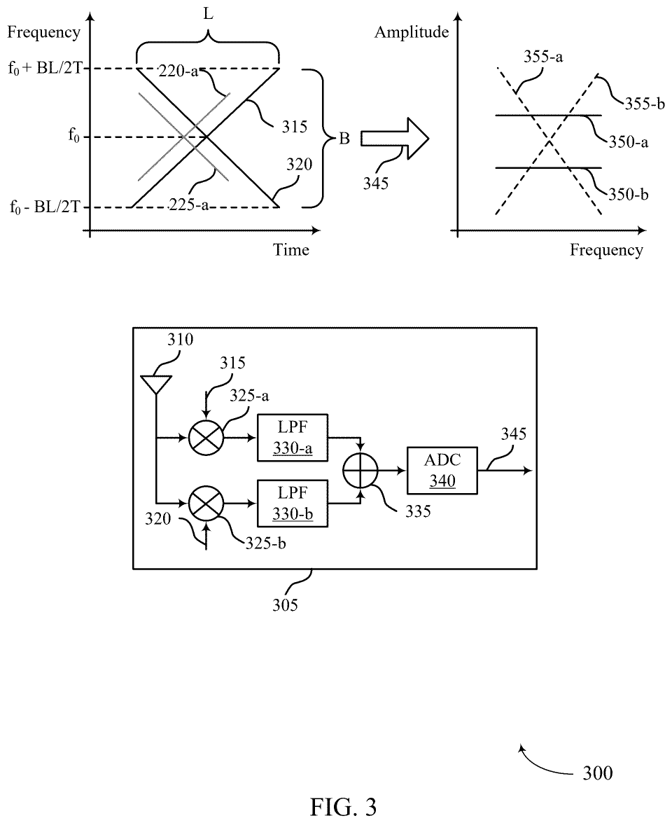

In some examples, the UE 115-a may descramble a respective hybrid X-FMCW signal 215 based on applying one or more candidate scrambling IDs, as described further herein with reference to FIG. 3. For example, the UE 115-a may descramble and receive information from the first hybrid X-FMCW signal 215-a based on identifying the scrambling ID corresponding to a successful candidate scrambling ID (e.g., the candidate scrambling ID that descrambled the first hybrid X-FMCW signal 215-a). In some examples, a pattern of the scrambled signal (e.g., a location of the scrambling on the first signal 220 and/or the second signal 225 or a position of the hybrid X-FMCW signal 215 in a burst transmission) may convey information associated with the network entity 105-a, as described further herein with reference to FIGS. 4A and 4B.

In some examples, the UE 115-a may communicate with the network entity 105-a based on descrambling one or more X-FMCW signals 215 (e.g., based on descrambling the first hybrid X-FMCW signal 215-a and/or the second hybrid X-FMCW signal 215-b). For example, the UE 115-a may transmit a first response message 230-a based on descrambling the one or more X-FMCW signals 215. In some examples, the UE 115-a may complete the cell search procedure based on descrambling the one or more X-FMCW signals 215, and the UE 115-a may transmit a first response message 230-a based on synchronizing with (e.g., connecting to) the network entity 105-a.

In some cases, the network entity 105-a may transmit an indication message 235 indicating one or more scrambling patterns associated with one or more procedures. For example, the network entity 105-a may transmit the indication message 235 indicating a scrambling pattern associated with an RF sensing procedure. In some examples, the network entity 105-a may transmit the indication message 235 based on receiving the first response message 230-a. Based on transmitting the indication message 235, the network entity 105-a may transmit a third hybrid X-FMCW signal 215-c to the UE 115-a. The UE 115-a may receive and descramble the third hybrid X-FMCW signal 215-c based on the indication message 235. In some examples, the UE 115-a may transmit a second response message 230-b in response to descrambling the third hybrid X-FMCW signal 215-c.

For example, the network entity 105-a may transmit the first hybrid X-FMCW signal 215-a and/or the second hybrid X-FMCW signal 215-b for a cell search procedure, and the first response message 230-a may be a response to the cell search procedure (e.g., indicating an ACK). In response to the successful cell search procedure, the network entity 105-a may indicate a different pattern (e.g., the network entity 105-a and the UE 115-a may assume a default scrambling pattern for cell search procedures) via the indication message 235. The UE 115-a may perform another procedure, such as beam management, updating time and/or frequency tracking loops, performing RRM (e.g., handover) and the like, based on receiving the third hybrid X-FMCW signal 215-c. The UE 115-a may transmit the second response message 230-b based on receiving the third hybrid X-FMCW signal 215-c. In some examples, the second response message 230-b may include information associated with the other procedure.

FIG. 3 shows an example of a receiver process 300 that supports hybrid FMCW design for cell search and measurement in accordance with one or more aspects of the present disclosure. In some examples, the receiver process 300 may implement or be implemented by aspects of the wireless communications system 100 or the wireless communications system 200, as described herein with reference to FIGS. 1 and 2. For example, one or more receivers (e.g., a receiver 305) configured to perform the receiver process 300 may be components of one or more UEs 115, as described herein with reference to FIGS. 1 and 2.

In some examples, the receiver 305 may receive at least a portion of a hybrid X-FMCW signal 310 (e.g., at least a portion of a wideband signal). The receiver 305 may receive the hybrid X-FMCW signal 310 using an antenna (not shown) (e.g., one or more antennas, antenna elements, antenna ports, antenna arrays, or any combination thereof). For example, the receiver 305 may receive a hybrid X-FMCW signal 310 transmitted by a network entity. In some examples, the hybrid X-FMCW signal 310 may include a first signal 220-a (e.g., an upchirp) and a second signal 225-a (e.g., a downchirp), as described herein with reference to FIG. 2. For example, at least a portion of the first signal 220-a, the second signal 225-a, or both, may be scrambled by the network entity in accordance with a scrambling ID.

In some examples, the receiver 305 may generate a first local signal 315 (e.g., an up-sweep FMCW) and a second local signal 320 (e.g., a down-sweep FMCW) to mix with the first signal 220-a and the second signal 225-b, respectively, via mixers 325. The local signals may be wideband signals (e.g., relative to the hybrid X-FMCW signal 310). The receiver 305 may generate the first local signal 315 and the second local signal 320 using one or more voltage-controlled oscillators (not shown). In some examples, the receiver 305 may mix the first signal 220-a with the first local signal 315 using a first mixer 325-a, and the receiver 305 may mix the second signal 225-a with the second local signal 320 using a second mixer 325-b. Each mixer 325 may include one or more components (e.g., hardware, software, or both) that are configured to mix (e.g., combine) two or more signals.

In some examples, the first local signal 315 may have a slope of B/L and the second local signal 320 may have a slope of

$$- \frac{B}{L} ,$$

where B is the bandwidth of the first local signal 315 and the second local signal 320, and L may be the time duration of the first local signal 315 and the second local signal 320. In some examples, the bandwidth of the local signals may be greater than or equal to the bandwidth of the first signal 220-a and the second signal 225-a. Additionally, or alternatively, the duration L may be greater than or equal to a duration T of the first signal 220-a and the second signal 225-a. In some examples, the first local signal 315 may increase from a lowest frequency,

$${f}_{0} - \frac{BL}{2 T} ,$$

to a highest frequency,

$${f}_{0} + \frac{BL}{2 T} ,$$

and the second local signal 320 may decrease from the highest frequency to the lowest frequency. It may be understood, however, that the first local signal 315 and the second local signal 320 may not necessarily be centered at f₀. That is, the receiver 305 may successfully receive and decode the hybrid X-FMCW signal 310 based on generating the first local signal 315 and the second local signal 320 within a respective bandwidth tolerance. In some examples, the first local signal 315 may not be symmetrical to the second local signal 320 (e.g., the local signals may have different slope values).

The receiver 305 may filter each of the mixed FMCW signals using low pass filters (LPFs) 330. For example, the receiver 305 may filter the mixed first signal 220-a and the first local signal 315 using a first LPF 330-a, and the receiver 305 may filter the mixed second signal 225-a and the second local signal 320 using a second LPF 330-b. Each of the LPFs 330 may be examples of components of the receiver 305 that are configured to filter signals, or functions supported by the receiver 305, or both. For example, the receiver 305 may apply an LPF function to each of the combined FMCW signals. In some examples, the receiver 305 may combine each of the filtered and mixed FMCW signals using an adder 335.

In some examples, the receiver 305 may use an analog-to-digital converter (ADC) 340 to sample the combined and filtered FMCW signal in the time domain. A sampling rate used to sample the combined and filtered FMCW signal may be based on one or more parameters (e.g., a de-scrambling process by the receiver 305). The receiver 305 may perform additional signal processing procedures 345, such as performing an FFT on the combined and filtered FMCW signal. The FFT may convert the filtered and combined FMCW signal from the time domain to the frequency domain. That is, the FFT may support demodulation of the filtered and combined FMCW signal.

In some examples, the receiver 305 may identify a scrambling ID corresponding to the hybrid X-FMCW signal 310 from a set of candidate scrambling IDs. As described herein, a candidate scrambling ID may be a possible scrambling ID used by the network entity to scramble the hybrid X-FMCW signal 310. A candidate scrambling ID may be referred to as a hypothesis scrambling ID (e.g., the UE may be unaware of which scrambling ID is used until it “tests” each one). A hypothesis scrambling ID may also be referred to as a candidate scrambling identifier. In some cases, the quantity of candidate scrambling IDs may be relatively small (e.g., 3, 8, or 12 possible scrambling IDs). A length of the scrambling IDs may also be relatively small (e.g., 3, 8, or 12 bits, among other examples). In some examples, the candidate scrambling IDs may be defined in a standard, and the UE may store the candidate scrambling IDs (e.g., in a table or codebook). Additionally, or alternatively, the UE may receive an indication of the candidate scrambling IDs (e.g., via the indication message 235 as described herein with reference to FIG. 2). The receiver 305 may use each candidate scrambling ID to attempt to descramble the hybrid X-FMCW signal 310 and determine the scrambling ID. That is, the receiver 305 may “test” each hypothesis scrambling ID to determine the scrambling ID used by the network entity.

In some examples, the receiver 305 may test each of the candidate scrambling IDs using one or more equations (e.g., equations defined in a standard). In some cases, the one or more equations may be similar to one or more equations used to calculate a PSS seed. The receiver 305 may detect the correct scrambling ID based on an output of the one or more equations resulting in beat frequencies 350 (e.g., two peaks in beat frequency domain). That is, other candidate scrambling IDs may not result in the beat frequencies 350. A first beat frequency 350-a may correspond to the second signal 225-a and a second beat frequency 350-b may correspond to the first signal 220-a. In some examples, the correct scrambling ID may also result in interference 355, where a first portion of the interference 355-a may correspond to the first signal 220-a and a second portion of the interference 355-b may correspond to the second signal 225-a. The receiver 305 may store the beat frequencies 350 and discard (e.g., ignore) the interference 355. In some examples, the energy of the interference 355 may be less than the energy of the beat frequencies 350 (e.g., based on identifying the correct scrambling ID).

The receiver 305 may identify the time and frequency information of the hybrid X-FMCW signal 310 based on detecting the beat frequencies 350. For example, by detecting the beat frequencies 350, the receiver 305 may differentiate different X-FMCW signals transmitted by different transmitters (e.g., different cells, different network entities 105, different UEs 115). In some examples, the beat frequencies 350 and/or the scrambling pattern used in the hybrid X-FMCW signal 310 may indicate information associated with the network entity. For example, the beat frequencies 350 may indicate time and frequency information of a raster point for a cell search procedure. Additionally, or alternatively, the scrambling ID may correspond to a cell ID or a group cell ID of the network entity. As described herein with reference to FIGS. 4A and 4B, the scrambling pattern may also indicate additional information (e.g., information associated with an RF sensing procedure, a positioning procedure, an RRM procedure, among other examples).

FIGS. 4A and 4B show examples of FMCW scrambling schemes for a respective hybrid X-FMCW signal 400-a and FMCW scrambling schemes for hybrid burst X-FMCW signal transmissions 400-b, respectively, that support hybrid FMCW design for cell search and measurement in accordance with one or more aspects of the present disclosure. The FMCW scrambling schemes for a respective hybrid X-FMCW signal 400-a may implement or be implemented by aspects of the wireless communications systems 100 and 200, as well as by the receiver process 300, as described herein with reference to FIGS. 1, 2, and 3. For example, a network entity may scramble one or more X-FMCW signals in accordance with the FMCW scrambling schemes, and a UE may receive and descramble the one or more X-FMCW signals via a receiver based on candidate scrambling IDs, as described herein with reference to FIG. 3. Within the X FMCW signal, part or all of the FMCW signal may be scrambled using time domain scrambling, frequency domain scrambling, or both.

In a first example scrambling scheme 405, a respective signal (e.g., a downchirp or upchirp) of the X-FMCW signal may be scrambled. That is, a complete chirp may be scrambled in accordance with a scrambling ID. For example, the second signal 225-b may be scrambled in accordance with the scrambling ID. In another example, the first signal 220-b may be scrambled in accordance with the scrambling ID. In some examples, such as for cell discovery, initial synchronization, or both, the quantity of scrambling ID hypothesis for the hybrid X-FMCW that a UE checks for may be relatively small. In some cases, a network entity may indicate a set of multiple scrambling ID hypotheses (e.g., via a control message, such as RRC, or other control signaling), and the UE may determine whether any part of a received X-FMCW signal is scrambled one of the multiple scrambling ID hypotheses. In other examples, the UE may be preconfigured with the set of multiple scrambling ID hypotheses to use when processing a received X-FMCW signal (e.g., the set of multiple scrambling ID hypotheses is specified in a standard with which the UE complies).

Additionally, or alternatively, both the first signal 220-b and the second signal 225-b may be scrambled. For example, the upchirp, downchirp, or both, may be scrambled based on the scrambling ID being a relatively small quantity of scrambling ID hypotheses for the UE to check (e.g., 3, 8, or 12 scrambling ID hypotheses). Relatively small scrambling ID scrambling ID hypotheses for fully-scrambled X-FMCW signals may not significantly reduce the dynamic range of the received X-FMCW signal at the UE. Additionally, the UE may be able to differentiate different X-FMCW signals that may be fully scrambled based on a length of a scrambling ID (e.g., scrambling sequence) not exceeding a threshold length (e.g., not exceeding 256 or 512 bits).

In a second example scrambling scheme 410, a portion of a respective signal of the X-FMCW signal may be scrambled. For example, a first portion of the second signal 225-c (e.g., a first half of the downchirp) may be scrambled. It may be understood that any portion of the first and second signals may be scrambled (e.g., the scrambling is not limited to a first half and may be any fraction of any chirp). As described herein, the scrambling ID may indicate information associated with the network entity. For example, the scrambling ID may be a function of a cell ID of the network entity or a cell group ID associated with the network entity.

Additionally, or alternatively, a pattern (e.g., a location or position) of the scrambled portion, such as in the first example scrambling scheme 405 or the second example scrambling scheme 410, may indicate information associated with the network entity. For example, which portion of the hybrid X-FMCW signal that is scrambled may be bitmapped (e.g., to carry a cell ID or cell ID group related information). That is, if a first half of the second signal 225-c is scrambled (e.g., from the highest frequency of the X-FMCW signal to the cross point), the portion may correspond to a logic ‘00.’ If a first half of the first signal 220-c is scrambled (e.g., from the lowest frequency of the X-FMCW signal to the cross point), the scrambled portion may correspond to a logic ‘01.’ Similarly, if the second half of the first signal 220-c is scrambled (e.g., from the cross point to the highest frequency of the X-FMCW signal), the scrambled portion may correspond to a logic ‘11,’ and if the second half of the second signal 225-c is scrambled (e.g., from the cross point to the lowest frequency of the X-FMCW signal), the scrambled portion may correspond to a logic ‘10.’ It may be understood that this is an example mapping for discussion purposes and other mapping schemes are possible.

In some examples, the network entity may scramble and transmit a hybrid X-FMCW signal in accordance with a default scrambling pattern (e.g., a scrambling pattern or scheme defined in standards). Any example scrambling pattern discussed herein, including the examples discussed in FIGS. 4A-4B, may be specified as being a default scrambling pattern. The UE may assume and descramble one or more hybrid X-FMCW signals in accordance with the default scrambling pattern. In some cases, using a default scrambling pattern may reduce UE receiver complexity. For example, a receiver (e.g., the receiver 305 as described herein with reference to FIG. 3) may detect and differentiate different X-FMCW signals more quickly by assuming the received X-FMCW signal is scrambled in accordance with the default scrambling pattern. In some examples, different procedures such as cell search, RF sensing, positioning, MMR, and the like, may correspond to different default scrambling patterns. For example, a default scrambling pattern for cell search may differ from a default scrambling pattern for RF sensing.

In some examples, the network entity may transmit one or more X-FMCW signals with a different scrambling pattern after initially transmitting one or more X-FMCW signals with the default scrambling pattern. For example, the UE may receive a hybrid X-FMCW signal with a default pattern for cell search, and based on completing the cell search procedure, the network entity may dynamically or semi-statically (e.g., periodically) change the scrambling pattern to indicate information, as described herein. In some examples, the network entity may change the scrambling pattern over time (e.g., based on a use case or procedure). As described further herein with reference to FIG. 2, the network entity may transmit an indication message (e.g., indication message 235) indicating the changed scrambling pattern.

The FMCW scrambling schemes for hybrid burst X-FMCW signal transmissions 400-b may implement or be implemented by aspects of the wireless communications systems 100 and 200, as well as by the receiver process 300, as described herein with reference to FIGS. 1, 2, and 3. For example, the network entity may scramble two or more X-FMCW signals in accordance with the FMCW scrambling schemes, and the UE may receive and descramble the two or more X-FMCW signals in a threshold duration via a receiver based on candidate scrambling IDs, as described herein with reference to FIG. 3. An X-FMCW transmission may be a burst transmission based on the transmission including two or more X-FMCW signals that are transmitted within a threshold duration (e.g., within a relatively short period of each other). As described herein, a hybrid burst X-FMCW signal transmission may include at least one X-FMCW signal with a scrambled portion, while other X-FMCW signals in the burst may not be scrambled. For example, a second X-FMCW signal in the burst may include a first signal 220-e and a second signal 225-e with no scrambled portions.

In a third example scrambling scheme 415, a burst transmission may include a hybrid X-FMCW signal with a fully-scrambled second signal 225-d. In another example, the first signal 220-d may be fully-scrambled (e.g., and the second signal 225-d may not be scrambled). Additionally, or alternatively, one or more X-FMCW signals in the burst transmission may include portions of first and second signals scrambled in accordance with any of the scrambling schemes as described herein, including the first example scrambling scheme 405 and/or the second example scrambling scheme 410.

In a fourth example scrambling scheme 420, a burst transmission may include an X-FMCW signal with both the first signal 220-f and the second signal 225-f being scrambled. In the fourth example scrambling scheme 420, the burst transmission may be a hybrid burst X-FMCW signal transmission because one or more other X-FMCW signals in the burst may not be scrambled. For example, the burst may include an X-FMCW signal with an unscrambled first signal 220-g and an unscrambled second signal 225-g.

As described herein, a position of a hybrid X-FMCW signal in a burst transmission may indicate information associated with the network entity. That is, an index of the hybrid X-FMCW signal in the burst transmission may indicate information. For example, a burst transmission may include 16 X-FMCW signals. If the hybrid X-FMCW signal is the second signal in the burst (e.g., the index is 2), the UE may receive information corresponding to that position (e.g., each index may correspond to a bitmap or other indication). For example, a beginning X-FMCW signal having at least a portion scrambled in a burst transmission may indicate a first cell ID or a first cell ID group related information (e.g., to indicate ‘00’), a second X-FMCW signal scrambled in a burst transmission may indicate a second cell ID or a second cell ID group related information (e.g., to indicate ‘01’), and so forth. In some examples, the index of the hybrid X-FMCW signal may be defined for different procedures (e.g., there may be a default position). For example, the index may be used for cell search procedures (e.g., identifying a cell ID or cell group ID based on the index), tracking loop updates (e.g., frequency tracking and/or time tracking), reference signal received power (RSRP) measurements for beam management (e.g., index 2 may indicate to measure beam 2), or measurements for handover or mobility procedures, among other examples.

In some examples, the network entity may transmit the burst transmission with a hybrid X-FMCW signal in a different position (e.g., the index of the hybrid X-FMCW signal may change) after initially transmitting a burst transmission with the default position. For example, the UE may receive a burst transmission with the hybrid X-FMCW signal in the default position for cell search, and based on completing the cell search procedure, the network entity may dynamically or semi-statically (e.g., periodically) change the position of the hybrid X-FMCW signal in a second burst transmission to indicate information, as described herein. In some examples, the network entity may change the position over time (e.g., based on a use case or procedure). As described further herein with reference to FIG. 2, the network entity may transmit an indication message (e.g., indication message 235) indicating the changed position of the hybrid X-FMCW signal within a burst transmission.

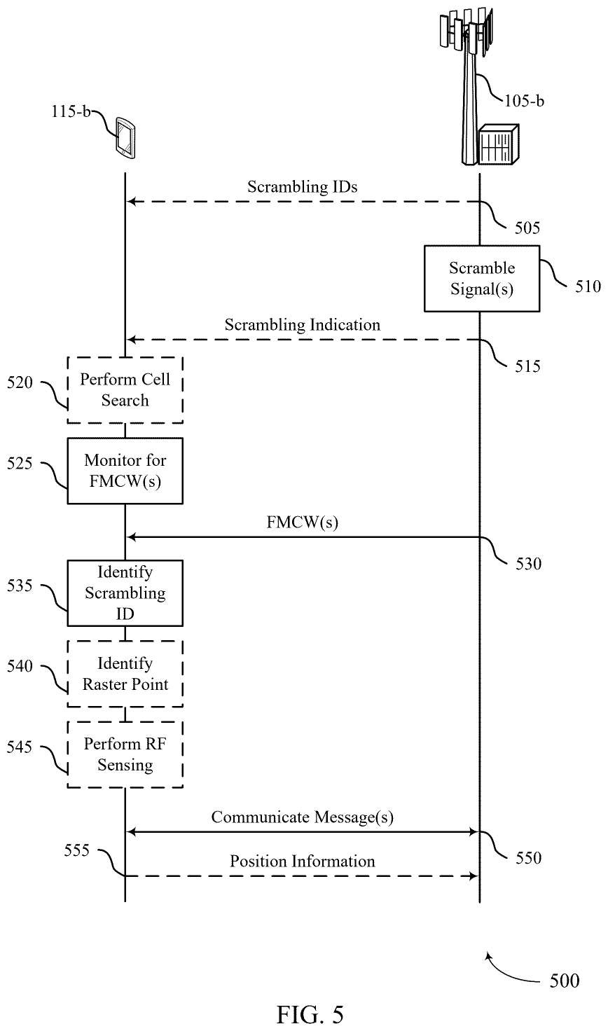

FIG. 5 shows an example of a process flow 500 that supports hybrid FMCW design for cell search and measurement in accordance with one or more aspects of the present disclosure. The process flow 500 may be implemented by aspects of the wireless communications systems 100 and 200, as well as by the receiver process 300. For example, a network entity 105-b and a UE 115-b, which may be examples of a network entity 105 or a UE 115, may perform aspects of the process flow 500. In the following description of the process flow 500, operations performed by the UE 115-b and the network entity 105-b may be performed in a different order than is shown. Some operations may be omitted from the process flow 500, and other operations may be added to the process flow 500. Further, although some operations or signaling may be shown to occur at different times for discussion purposes, these operations may occur at the same time.

At 505, the UE 115-b may receive configuration information indicating multiple candidate scrambling IDs. Each of the multiple candidate scrambling IDs may be applied to an FMCW signal in accordance with the configuration information, as described herein with reference to FIG. 3. In some examples, the UE 115-b may receive the configuration information from the network entity 105-b. Additionally, or alternatively, the UE 115-b may obtain the configuration information based on a set of defined candidate scrambling IDs.

At 510, the network entity 105-b may scramble a portion of a first signal, a second signal, or both (e.g., of an FMCW signal) in a time domain, a frequency domain, or both. That is, the network entity 105-b may scramble the portion of the first signal, the second signal, or both, in accordance with a scrambling ID from the multiple candidate scrambling IDs. In some cases, both the first signal and the second signal may be scrambled in accordance with the scrambling ID. In some examples, the network entity 105-b may scramble the portion of the first signal, the second signal, or both, based on obtaining configuration information indicating a scrambling pattern or position of the portion of the first signal, the second signal, or both.

The scrambling ID may be a function of cell information of the cell. For example, the scrambling ID may be a function of a cell ID or a cell group ID. In some examples, the scrambling pattern or a location of the portion (e.g., the scrambled portion) of the first signal, the second signal, or both, may indicate additional cell information. In some examples, the network entity 105-b may scramble a portion of an X-FMCW signal within an FMCW burst transmission of two or more X-FMCW signals. The additional cell information may indicate, for example, a tracking loop update, beam management information, RRM information, or the like, or any combination of thereof.

At 515, the UE 115-b may receive configuration information indicating a position of the FMCW signal in the FMCW burst transmission. For example, the network entity 105-b may transmit the configuration information (e.g., via the indication message 235). In some other examples, the UE 115-b may obtain the configuration information based on a defined position of the FMCW signal in the FMCW burst transmission (e.g., the position may be a default position). Additionally, or alternatively, the configuration information may indicate a scrambling pattern of an FMCW signal (e.g., an FMCW signal not within the FMCW burst transmission).

In some examples, at 520, the UE 115-b may perform a cell search procedure within a bandwidth. In such examples, the network entity 105-b may communicate the FMCW signal at a raster frequency of multiple raster frequencies within the bandwidth. For example, a cross point of the FMCW signal may correspond to the raster location.

At 525, the UE 115-b may monitor, over the bandwidth, for one or more FMCW signals associated with a cell (e.g., the network entity 105-b). In some examples, a respective FMCW signal may include a first signal (e.g., upchirp) that increases in frequency from a first frequency to a second frequency in a time interval and a second signal (e.g., downchirp) that decreases in frequency from the second frequency to the first frequency in the time interval. That is, the UE 115-b may monitor for one or more X-FMCW signals. As described herein, a portion of the first signal, the second signal, or both, may be scrambled in accordance with a scrambling ID.

At 530, the network entity 105-b may output the one or more FMCW signals associated with the cell over the bandwidth. In some examples, the UE 115-b may receive the one or more FMCW signals based on monitoring for the one or more FMCW signals. For example, the UE 115-b may receive an FMCW burst transmission including the FMCW signal and at least a second FMCW signal, where the second FMCW signal may include a third signal (e.g., upchirp) that increases in frequency from a third frequency to a fourth frequency in a second time interval and a fourth signal (e.g., downchirp) that decreases in frequency from the fourth frequency to the third frequency in the second time interval. In some examples, a position of the FMCW signal in the FMCW burst transmission relative to the second FMCW signal may indicate additional cell information of the cell, as described herein with reference to FIG. 4B.

At 535, the UE 115-b may identify, based at least in part on the FMCW signal, the scrambling ID from the multiple candidate scrambling IDs. In some examples, the UE 115-b may identify the scrambling ID based at least in part on the scrambling ID descrambling at least the portion of the first signal, the second signal, or both, of the FMCW signal, as described herein with reference to FIG. 3. Additionally, or alternatively, the UE 115-b may identify the scrambling ID based at least in part on a default scrambling pattern at the UE 115-b.

In some examples, at 540, the UE 115-b may identify a raster location and the raster frequency associated with the cell based at least in part on reception of the FMCW signal at the raster frequency. For example, the UE 115-b may identify the raster location and the raster frequency based on identifying the scrambling ID. Additionally, or alternatively, at 545, the UE 115-b may perform an RF sensing operation associated with the UE 115-b based at least in part on the FMCW signal and the scrambling ID (e.g., based on identifying the scrambling ID).

At 550, the UE 115-b may communicate one or more messages with the cell (e.g., the network entity 105-b) based at least in part on the cell information. In some examples, the UE 115-b and/or the network entity 105-b may communicate the one or more messages based at least in part on the raster frequency. In some examples, at 555, the UE 115-b may communicate information associated with a position of the UE 115-b based at least in part on the FMCW signal and the scrambling ID.

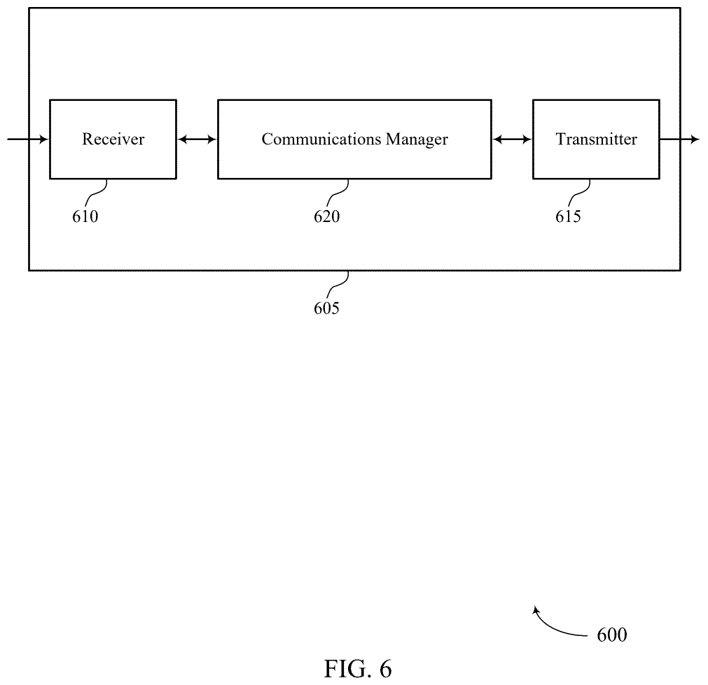

FIG. 6 shows a block diagram 600 of a device 605 that supports hybrid FMCW design for cell search and measurement in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to hybrid FMCW design for cell search and measurement). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to hybrid FMCW design for cell search and measurement). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of hybrid FMCW design for cell search and measurement as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for monitoring, over a bandwidth, for an FMCW signal associated with a cell, where the FMCW signal includes a first signal that increases in frequency from a first frequency to a second frequency in a time interval and a second signal that decreases in frequency from the second frequency to the first frequency in the time interval, and where at least a portion of the first signal, the second signal, or both, is scrambled in accordance with a scrambling identifier. The communications manager 620 is capable of, configured to, or operable to support a means for identifying, based at least in part on the FMCW signal, the scrambling identifier from a set of multiple candidate scrambling identifiers, where the scrambling identifier is a function of cell information of the cell. The communications manager 620 is capable of, configured to, or operable to support a means for communicating one or more messages with the cell based on the cell information.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources, among other examples.

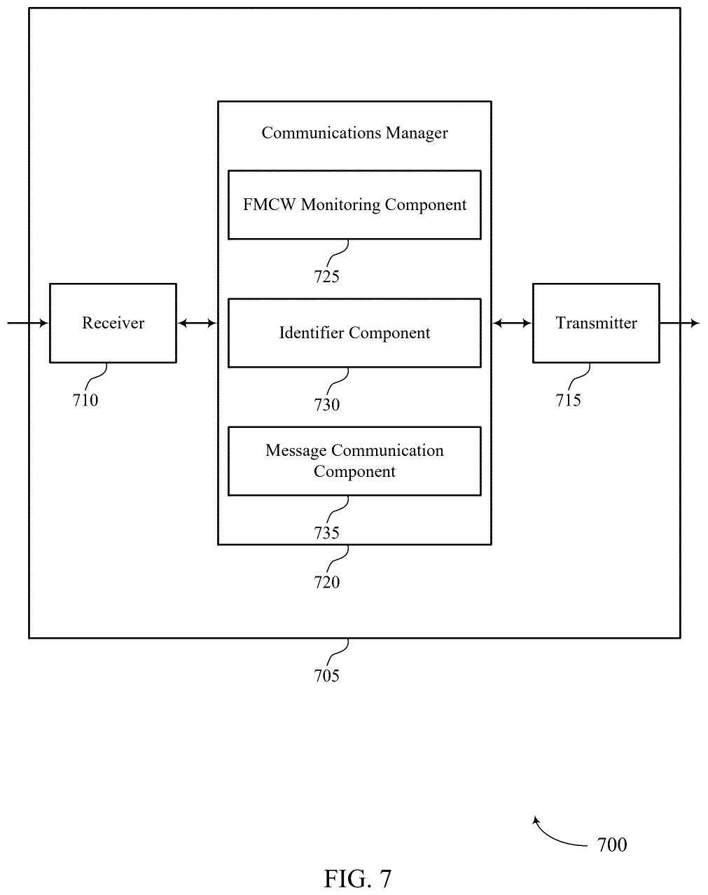

FIG. 7 shows a block diagram 700 of a device 705 that supports hybrid FMCW design for cell search and measurement in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to hybrid FMCW design for cell search and measurement). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to hybrid FMCW design for cell search and measurement). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of hybrid FMCW design for cell search and measurement as described herein. For example, the communications manager 720 may include an FMCW monitoring component 725, an identifier component 730, a message communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The FMCW monitoring component 725 is capable of, configured to, or operable to support a means for monitoring, over a bandwidth, for an FMCW signal associated with a cell, where the FMCW signal includes a first signal that increases in frequency from a first frequency to a second frequency in a time interval and a second signal that decreases in frequency from the second frequency to the first frequency in the time interval, and where at least a portion of the first signal, the second signal, or both, is scrambled in accordance with a scrambling identifier. The identifier component 730 is capable of, configured to, or operable to support a means for identifying, based on the FMCW signal, the scrambling identifier from a set of multiple candidate scrambling identifiers, where the scrambling identifier is a function of cell information of the cell. The message communication component 735 is capable of, configured to, or operable to support a means for communicating one or more messages with the cell based on the cell information.

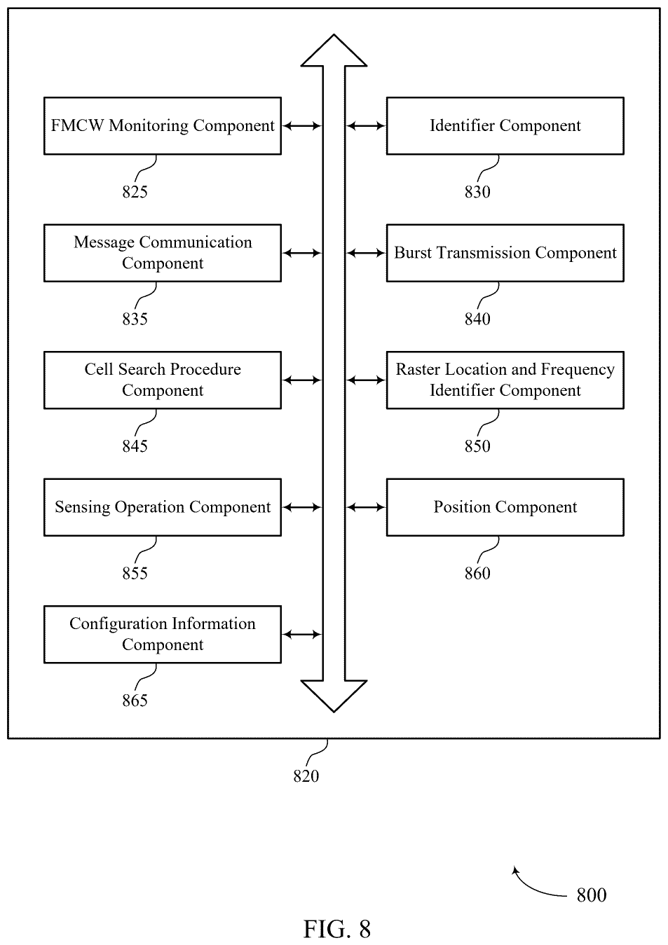

FIG. 8 shows a block diagram 800 of a communications manager 820 that supports hybrid FMCW design for cell search and measurement in accordance with one or more aspects of the present disclosure. The communications manager 820 may be an example of aspects of a communications manager 620, a communications manager 720, or both, as described herein. The communications manager 820, or various components thereof, may be an example of means for performing various aspects of hybrid FMCW design for cell search and measurement as described herein. For example, the communications manager 820 may include an FMCW monitoring component 825, an identifier component 830, a message communication component 835, a burst transmission component 840, a cell search procedure component 845, a raster location and frequency identifier component 850, a sensing operation component 855, a position component 860, a configuration information component 865, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The FMCW monitoring component 825 is capable of, configured to, or operable to support a means for monitoring, over a bandwidth, for an FMCW signal associated with a cell, where the FMCW signal includes a first signal that increases in frequency from a first frequency to a second frequency in a time interval and a second signal that decreases in frequency from the second frequency to the first frequency in the time interval, and where at least a portion of the first signal, the second signal, or both, is scrambled in accordance with a scrambling identifier. The identifier component 830 is capable of, configured to, or operable to support a means for identifying, based on the FMCW signal, the scrambling identifier from a set of multiple candidate scrambling identifiers, where the scrambling identifier is a function of cell information of the cell. The message communication component 835 is capable of, configured to, or operable to support a means for communicating one or more messages with the cell based on the cell information.

In some examples, the burst transmission component 840 is capable of, configured to, or operable to support a means for receiving an FMCW burst transmission including the FMCW signal and at least a second FMCW signal, where the second FMCW signal includes a third signal that increases in frequency from a third frequency to a fourth frequency in a second time interval and a fourth signal that decreases in frequency from the fourth frequency to the third frequency in the second time interval. In some examples, a position of the FMCW signal in the FMCW burst transmission relative to the second FMCW signal indicates additional cell information of the cell.

In some examples, the configuration information component 865 is capable of, configured to, or operable to support a means for receiving configuration information indicating a position of the FMCW signal in the FMCW burst transmission. In some examples, the scrambling identifier is identified based on the scrambling identifier descrambling at least the portion of the first signal, the second signal, or both, of the FMCW signal.

In some examples, the configuration information component 865 is capable of, configured to, or operable to support a means for receiving configuration information indicating the set of multiple candidate scrambling identifiers, where each of the set of multiple candidate scrambling identifiers is applied to the FMCW signal in accordance with the configuration information. In some examples, a scrambling pattern or a location of the portion of the first signal, the second signal, or both, indicates additional cell information. In some examples, the scrambling identifier is identified based on a default scrambling pattern at the UE.

In some examples, the cell search procedure component 845 is capable of, configured to, or operable to support a means for performing a cell search procedure within the bandwidth, where the FMCW signal is communicated at a raster frequency of a set of multiple raster frequencies within the bandwidth. In some examples, the raster location and frequency identifier component 850 is capable of, configured to, or operable to support a means for identifying a raster location and the raster frequency associated with the cell based on reception of the FMCW signal at the raster frequency, where the one or more messages are communicated with the cell based on the raster frequency.

In some examples, the sensing operation component 855 is capable of, configured to, or operable to support a means for performing a radio frequency sensing operation associated with the UE based on the FMCW signal and the scrambling identifier. In some examples, the position component 860 is capable of, configured to, or operable to support a means for communicating information associated with a position of the UE based on the FMCW signal and the scrambling identifier.

In some examples, the cell information includes a cell identifier or a cell group identifier. In some examples, both the first signal and the second signal are scrambled in accordance with the scrambling identifier. In some examples, the portion of the first signal, the second signal, or both, is scrambled in a time domain, a frequency domain, or both.

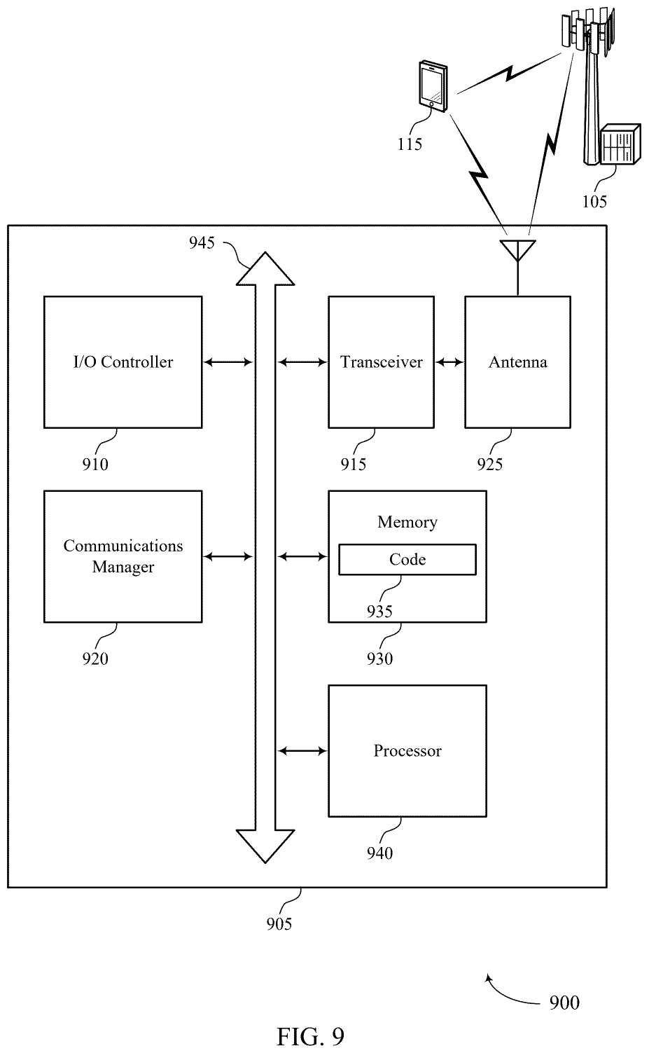

FIG. 9 shows a diagram of a system 900 including a device 905 that supports hybrid FMCW design for cell search and measurement in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting hybrid FMCW design for cell search and measurement). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for monitoring, over a bandwidth, for an FMCW signal associated with a cell, where the FMCW signal includes a first signal that increases in frequency from a first frequency to a second frequency in a time interval and a second signal that decreases in frequency from the second frequency to the first frequency in the time interval, and where at least a portion of the first signal, the second signal, or both, is scrambled in accordance with a scrambling identifier. The communications manager 920 is capable of, configured to, or operable to support a means for identifying, based at least in part on the FMCW signal, the scrambling identifier from a set of multiple candidate scrambling identifiers, where the scrambling identifier is a function of cell information of the cell. The communications manager 920 is capable of, configured to, or operable to support a means for communicating one or more messages with the cell based on the cell information.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability, among other examples.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described herein with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of hybrid FMCW design for cell search and measurement as described herein, or the at least one processor 940 and the at least one memory 930 may be otherwise configured to, individually or collectively, perform or support such operations.

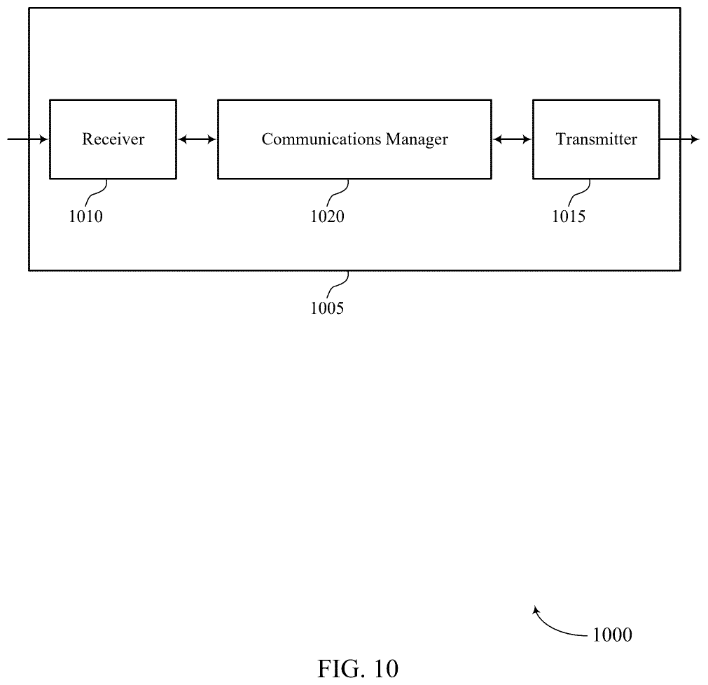

FIG. 10 shows a block diagram 1000 of a device 1005 that supports hybrid FMCW design for cell search and measurement in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of hybrid FMCW design for cell search and measurement as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting, over a bandwidth, an FMCW signal associated with a cell, the FMCW signal including a first signal that increases in frequency from a first frequency to a second frequency in a time interval and a second signal that decreases in frequency from the second frequency to the first frequency in the time interval, where at least a portion of the first signal, the second signal, or both, is scrambled in accordance with a scrambling identifier from a set of multiple candidate scrambling identifiers, and where the scrambling identifier is a function of cell information of the cell. The communications manager 1020 is capable of, configured to, or operable to support a means for communicating one or more messages with a UE based on the cell information.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources, among other examples.

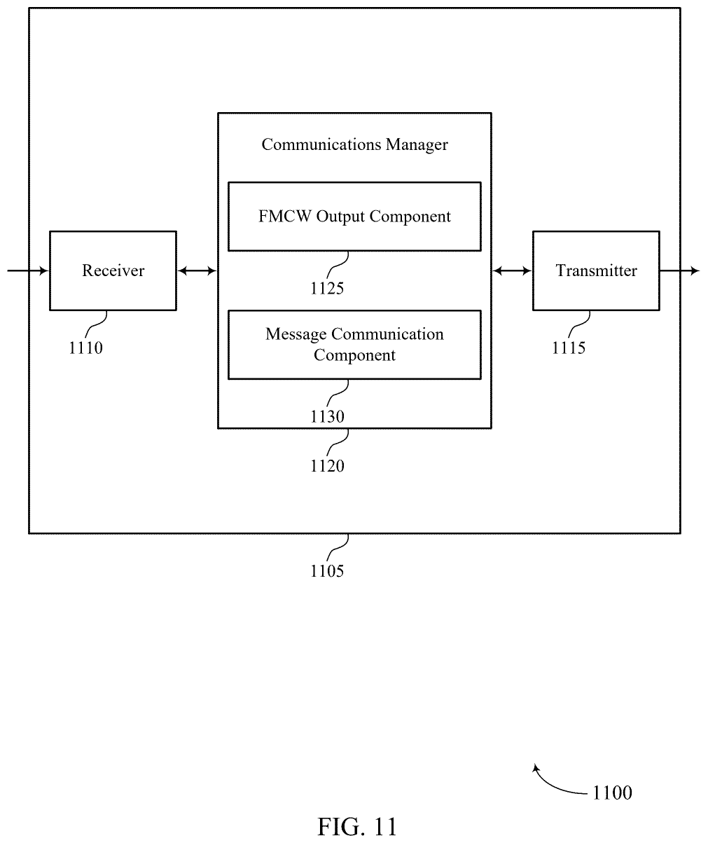

FIG. 11 shows a block diagram 1100 of a device 1105 that supports hybrid FMCW design for cell search and measurement in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of hybrid FMCW design for cell search and measurement as described herein. For example, the communications manager 1120 may include an FMCW output component 1125 a message communication component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The FMCW output component 1125 is capable of, configured to, or operable to support a means for outputting, over an FMCW signal associated with a cell, the FMCW signal including a first signal that increases in frequency from a first frequency to a second frequency in a time interval and a second signal that decreases in frequency from the second frequency to the first frequency in the time interval, where at least a portion of the first signal, the second signal, or both, is scrambled in accordance with a scrambling identifier from a set of multiple candidate scrambling identifiers, and where the scrambling identifier is a function of cell information of the cell. The message communication component 1130 is capable of, configured to, or operable to support a means for communicating one or more messages with a UE based on the cell information.

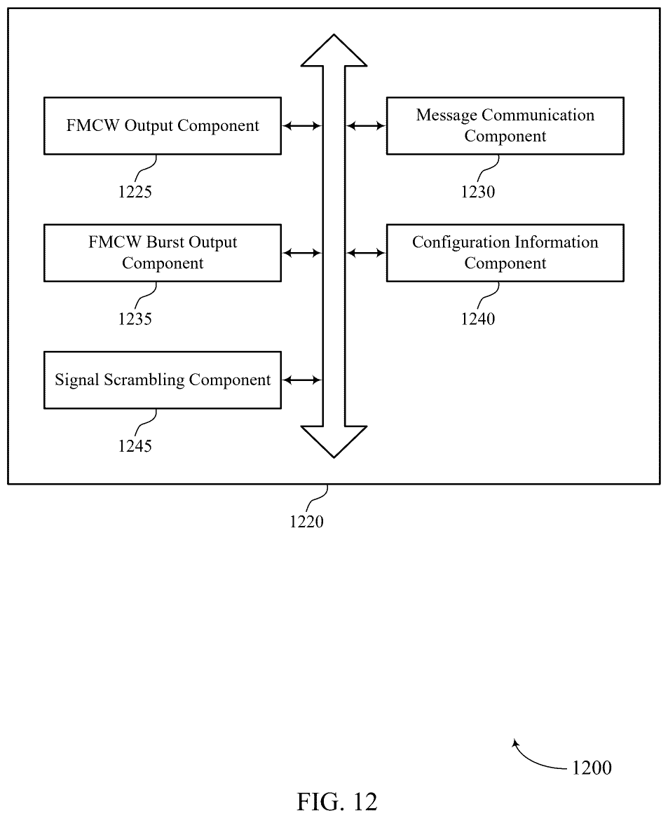

FIG. 12 shows a block diagram 1200 of a communications manager 1220 that supports hybrid FMCW design for cell search and measurement in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of hybrid FMCW design for cell search and measurement as described herein. For example, the communications manager 1220 may include an FMCW output component 1225, a message communication component 1230, an FMCW burst output component 1235, a configuration information component 1240, a signal scrambling component 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The FMCW output component 1225 is capable of, configured to, or operable to support a means for outputting, over a bandwidth, an FMCW signal associated with a cell, the FMCW signal including a first signal that increases in frequency from a first frequency to a second frequency in a time interval and a second signal that decreases in frequency from the second frequency to the first frequency in the time interval, where at least a portion of the first signal, the second signal, or both, is scrambled in accordance with a scrambling identifier from a set of multiple candidate scrambling identifiers, and where the scrambling identifier is a function of cell information of the cell. The message communication component 1230 is capable of, configured to, or operable to support a means for communicating one or more messages with a UE based on the cell information.

In some examples, the FMCW burst output component 1235 is capable of, configured to, or operable to support a means for outputting an FMCW burst transmission including the FMCW signal and at least a second FMCW signal, where the second FMCW signal includes a third signal that increases in frequency from a third frequency to a fourth frequency in a second time interval and a fourth signal that decreases in frequency from the fourth frequency to the third frequency in the second time interval. In some examples, a position of the FMCW signal in the FMCW burst transmission relative to the second FMCW signal indicates additional cell information of the cell. In some examples, the configuration information component 1240 is capable of, configured to, or operable to support a means for obtaining configuration information indicating a position of the FMCW signal in the FMCW burst transmission.

In some examples, the configuration information component 1240 is capable of, configured to, or operable to support a means for obtaining configuration information indicating the set of multiple candidate scrambling identifiers, where the portion of the first signal, the second signal, or both, is scrambled in accordance with the configuration information. In some examples, a scrambling pattern or a location of the portion of the first signal, the second signal, or both, indicates additional cell information of the cell.

In some examples, the configuration information component 1240 is capable of, configured to, or operable to support a means for obtaining configuration information indicating a scrambling pattern or a position of the portion of the first signal, the second signal, or both, where the portion of the first signal, the second signal, or both, is scrambled based on the configuration information. In some examples, the FMCW signal is output at a raster frequency of a set of multiple raster frequencies within the bandwidth. In some examples, the one or more messages are communicated with the UE based on the raster frequency.

In some examples, the signal scrambling component 1245 is capable of, configured to, or operable to support a means for scrambling the portion of the first signal, the second signal, or both, in a time domain, a frequency domain, or both. In some examples, the cell information includes a cell identifier or a cell group identifier. In some examples, both the first signal and the second signal are scrambled in accordance with the scrambling identifier.

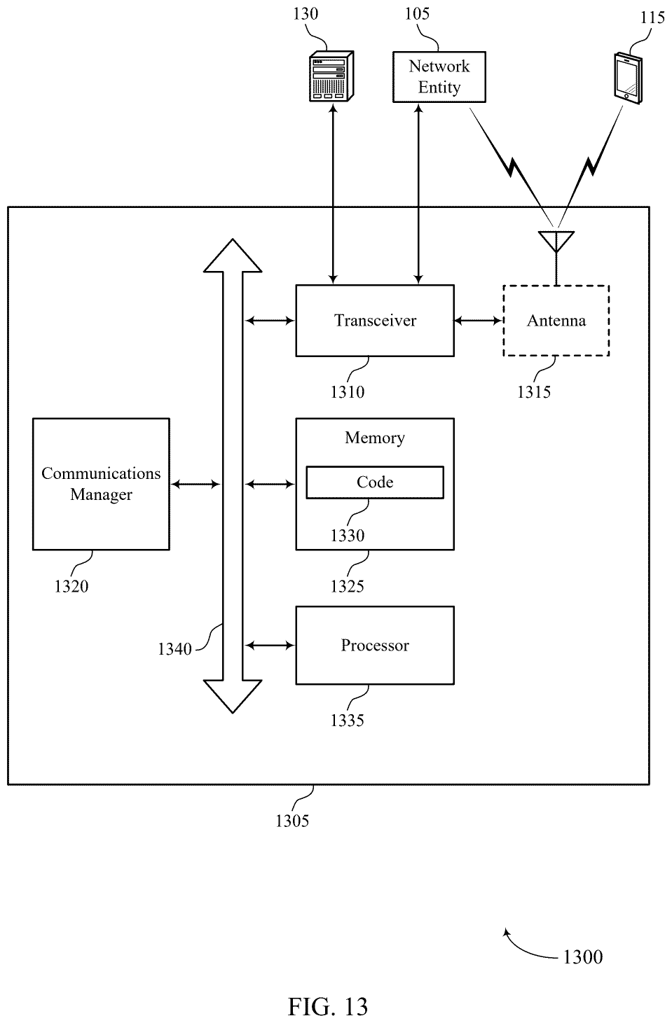

FIG. 13 shows a diagram of a system 1300 including a device 1305 that supports hybrid FMCW design for cell search and measurement in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting hybrid FMCW design for cell search and measurement). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting, over a bandwidth, an FMCW signal associated with a cell, the FMCW signal including a first signal that increases in frequency from a first frequency to a second frequency in a time interval and a second signal that decreases in frequency from the second frequency to the first frequency in the time interval, where at least a portion of the first signal, the second signal, or both, is scrambled in accordance with a scrambling identifier from a set of multiple candidate scrambling identifiers, and where the scrambling identifier is a function of cell information of the cell. The communications manager 1320 is capable of, configured to, or operable to support a means for communicating one or more messages with a UE based on the cell information.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability, among other examples.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described herein with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of hybrid FMCW design for cell search and measurement as described herein, or the at least one processor 1335 and the at least one memory 1325 may be otherwise configured to, individually or collectively, perform or support such operations.

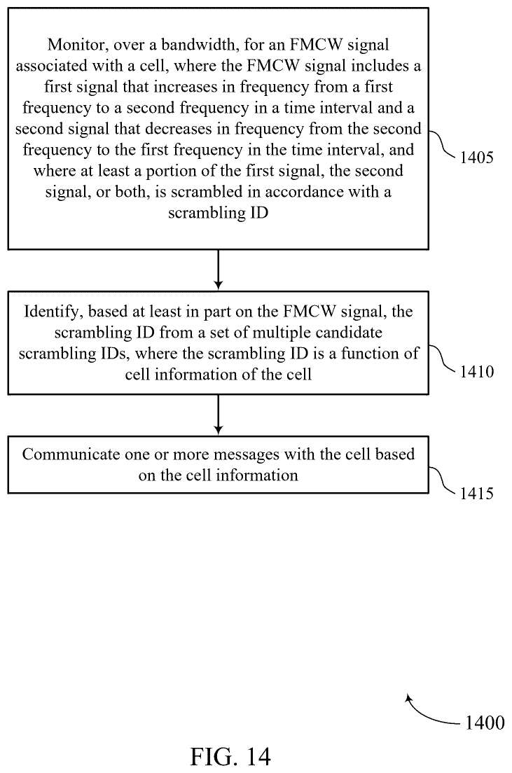

FIG. 14 shows a flowchart illustrating a method 1400 that supports hybrid FMCW design for cell search and measurement in accordance with one or more aspects of the present disclosure. The operations of the method 1400 may be implemented by a UE or its components as described herein. For example, the operations of the method 1400 may be performed by a UE 115 as described herein with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include monitoring, over a bandwidth, for an FMCW signal associated with a cell, where the FMCW signal includes a first signal that increases in frequency from a first frequency to a second frequency in a time interval and a second signal that decreases in frequency from the second frequency to the first frequency in the time interval, and where at least a portion of the first signal, the second signal, or both, is scrambled in accordance with a scrambling identifier. The operations of 1405 may be performed in accordance with examples as disclosed herein. In some examples, aspects of the operations of 1405 may be performed by an FMCW monitoring component 825 as described herein with reference to FIG. 8.

At 1410, the method may include identifying, based on the FMCW signal, the scrambling identifier from a set of multiple candidate scrambling identifiers, where the scrambling identifier is a function of cell information of the cell. The operations of 1410 may be performed in accordance with examples as disclosed herein. In some examples, aspects of the operations of 1410 may be performed by an identifier component 830 as described herein with reference to FIG. 8.

At 1415, the method may include communicating one or more messages with the cell based on the cell information. The operations of 1415 may be performed in accordance with examples as disclosed herein. In some examples, aspects of the operations of 1415 may be performed by a message communication component 835 as described herein with reference to FIG. 8.

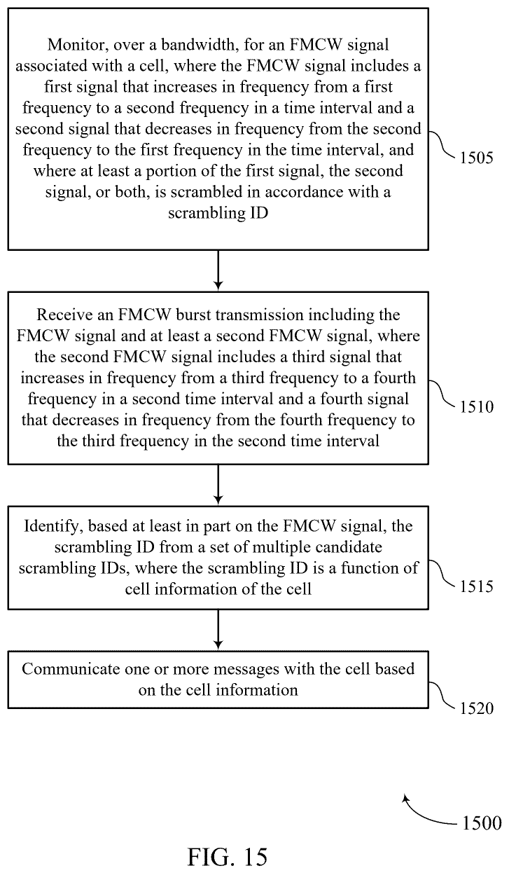

FIG. 15 shows a flowchart illustrating a method 1500 that supports hybrid FMCW design for cell search and measurement in accordance with one or more aspects of the present disclosure. The operations of the method 1500 may be implemented by a UE or its components as described herein. For example, the operations of the method 1500 may be performed by a UE 115 as described herein with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include monitoring, over a bandwidth, for an FMCW signal associated with a cell, where the FMCW signal includes a first signal that increases in frequency from a first frequency to a second frequency in a time interval and a second signal that decreases in frequency from the second frequency to the first frequency in the time interval, and where at least a portion of the first signal, the second signal, or both, is scrambled in accordance with a scrambling identifier. The operations of 1505 may be performed in accordance with examples as disclosed herein. In some examples, aspects of the operations of 1505 may be performed by an FMCW monitoring component 825 as described herein with reference to FIG. 8.

At 1510, the method may include receiving an FMCW burst transmission including the FMCW signal and at least a second FMCW signal, where the second FMCW signal includes a third signal that increases in frequency from a third frequency to a fourth frequency in a second time interval and a fourth signal that decreases in frequency from the fourth frequency to the third frequency in the second time interval. The operations of 1510 may be performed in accordance with examples as disclosed herein. In some examples, aspects of the operations of 1510 may be performed by a burst transmission component 840 as described herein with reference to FIG. 8.

At 1515, the method may include identifying, based on the FMCW signal, the scrambling identifier from a set of multiple candidate scrambling identifiers, where the scrambling identifier is a function of cell information of the cell. The operations of 1515 may be performed in accordance with examples as disclosed herein. In some examples, aspects of the operations of 1515 may be performed by an identifier component 830 as described herein with reference to FIG. 8.

At 1520, the method may include communicating one or more messages with the cell based on the cell information. The operations of 1520 may be performed in accordance with examples as disclosed herein. In some examples, aspects of the operations of 1520 may be performed by a message communication component 835 as described herein with reference to FIG. 8.

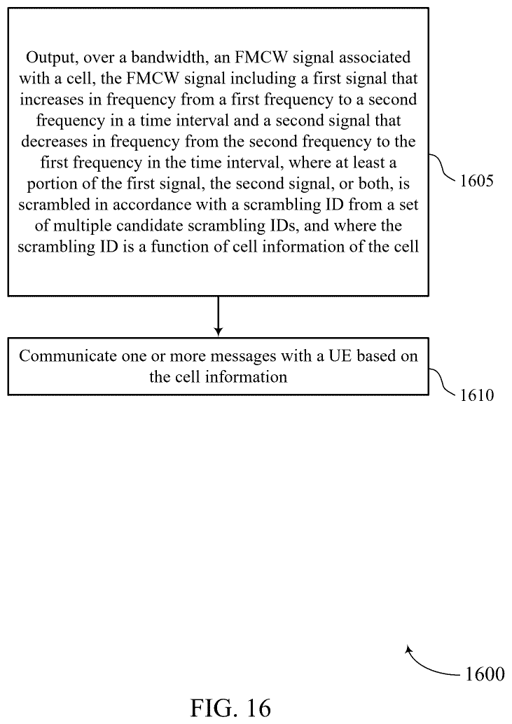

FIG. 16 shows a flowchart illustrating a method 1600 that supports hybrid FMCW design for cell search and measurement in accordance with one or more aspects of the present disclosure. The operations of the method 1600 may be implemented by a network entity or its components as described herein. For example, the operations of the method 1600 may be performed by a network entity as described herein with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting, over a bandwidth, an FMCW signal associated with a cell, the FMCW signal including a first signal that increases in frequency from a first frequency to a second frequency in a time interval and a second signal that decreases in frequency from the second frequency to the first frequency in the time interval, where at least a portion of the first signal, the second signal, or both, is scrambled in accordance with a scrambling identifier from a set of multiple candidate scrambling identifiers, and where the scrambling identifier is a function of cell information of the cell. The operations of 1605 may be performed in accordance with examples as disclosed herein. In some examples, aspects of the operations of 1605 may be performed by an FMCW output component 1225 as described herein with reference to FIG. 12.

At 1610, the method may include communicating one or more messages with a UE based on the cell information. The operations of 1610 may be performed in accordance with examples as disclosed herein. In some examples, aspects of the operations of 1610 may be performed by a message communication component 1230 as described herein with reference to FIG. 12.

The following provides an overview of aspects of the present disclosure:

Aspect 1: A method for wireless communications at a UE, comprising: monitoring, over a bandwidth, for an FMCW signal associated with a cell, wherein the FMCW signal comprises a first signal that increases in frequency from a first frequency to a second frequency in a time interval and a second signal that decreases in frequency from the second frequency to the first frequency in the time interval, and wherein at least a portion of the first signal, the second signal, or both, is scrambled in accordance with a scrambling identifier; identifying, based at least in part on the FMCW signal, the scrambling identifier from a plurality of candidate scrambling identifiers, wherein the scrambling identifier is a function of cell information of the cell; and communicating one or more messages with the cell based at least in part on the cell information.

Aspect 2: The method of aspect 1, further comprising: receiving an FMCW burst transmission comprising the FMCW signal and at least a second FMCW signal, wherein the second FMCW signal comprises a third signal that increases in frequency from a third frequency to a fourth frequency in a second time interval and a fourth signal that decreases in frequency from the fourth frequency to the third frequency in the second time interval.

Aspect 3: The method of aspect 2, wherein a position of the FMCW signal in the FMCW burst transmission relative to the second FMCW signal indicates additional cell information of the cell.

Aspect 4: The method of any of aspects 2 through 3, further comprising: receiving configuration information indicating a position of the FMCW signal in the FMCW burst transmission.

Aspect 5: The method of any of aspects 1 through 4, wherein the scrambling identifier is identified based at least in part on the scrambling identifier descrambling at least the portion of the first signal, the second signal, or both, of the FMCW signal.

Aspect 6: The method of aspect 5, further comprising: receiving configuration information indicating the plurality of candidate scrambling identifiers, wherein each of the plurality of candidate scrambling identifiers is applied to the FMCW signal in accordance with the configuration information.

Aspect 7: The method of any of aspects 1 through 6, wherein a scrambling pattern or a location of the portion of the first signal, the second signal, or both, indicates additional cell information.

Aspect 8: The method of any of aspects 1 through 7, wherein the scrambling identifier is identified based at least in part on a default scrambling pattern at the UE.

Aspect 9: The method of any of aspects 1 through 8, further comprising: performing a cell search procedure within the bandwidth, wherein the FMCW signal is communicated at a raster frequency of a plurality of raster frequencies within the bandwidth; and identifying a raster location and the raster frequency associated with the cell based at least in part on reception of the FMCW signal at the raster frequency, wherein the one or more messages are communicated with the cell based at least in part on the raster frequency.

Aspect 10: The method of any of aspects 1 through 9, further comprising: performing a radio frequency sensing operation associated with the UE based at least in part on the FMCW signal and the scrambling identifier.

Aspect 11: The method of any of aspects 1 through 10, further comprising: communicating information associated with a position of the UE based at least in part on the FMCW signal and the scrambling identifier.

Aspect 12: The method of any of aspects 1 through 11, wherein the cell information comprises a cell identifier or a cell group identifier.

Aspect 13: The method of any of aspects 1 through 12, wherein both the first signal and the second signal are scrambled in accordance with the scrambling identifier.

Aspect 14: The method of any of aspects 1 through 13, wherein the portion of the first signal, the second signal, or both, is scrambled in a time domain, a frequency domain, or both.

Aspect 15: A method for wireless communications at a network entity, comprising: outputting, over a bandwidth, an FMCW signal associated with a cell, the FMCW signal comprising a first signal that increases in frequency from a first frequency to a second frequency in a time interval and a second signal that decreases in frequency from the second frequency to the first frequency in the time interval, wherein at least a portion of the first signal, the second signal, or both, is scrambled in accordance with a scrambling identifier from a plurality of candidate scrambling identifiers, and wherein the scrambling identifier is a function of cell information of the cell; and communicating one or more messages with a UE based at least in part on the cell information.

Aspect 16: The method of aspect 15, further comprising: outputting an FMCW burst transmission comprising the FMCW signal and at least a second FMCW signal, wherein the second FMCW signal comprises a third signal that increases in frequency from a third frequency to a fourth frequency in a second time interval and a fourth signal that decreases in frequency from the fourth frequency to the third frequency in the second time interval.

Aspect 17: The method of aspect 16, wherein a position of the FMCW signal in the FMCW burst transmission relative to the second FMCW signal indicates additional cell information of the cell.

Aspect 18: The method of any of aspects 16 through 17, further comprising: obtaining configuration information indicating a position of the FMCW signal in the FMCW burst transmission.

Aspect 19: The method of any of aspects 15 through 18, further comprising: obtaining configuration information indicating the plurality of candidate scrambling identifiers, wherein the portion of the first signal, the second signal, or both, is scrambled in accordance with the configuration information.

Aspect 20: The method of any of aspects 15 through 19, wherein a scrambling pattern or a location of the portion of the first signal, the second signal, or both, indicates additional cell information of the cell.

Aspect 21: The method of any of aspects 15 through 20, further comprising: obtaining configuration information indicating a scrambling pattern or a position of the portion of the first signal, the second signal, or both, wherein the portion of the first signal, the second signal, or both, is scrambled based at least in part on the configuration information.

Aspect 22: The method of any of aspects 15 through 21, wherein the FMCW signal is output at a raster frequency of a plurality of raster frequencies within the bandwidth, and the one or more messages are communicated with the UE based at least in part on the raster frequency.

Aspect 23: The method of any of aspects 15 through 22, further comprising: scrambling the portion of the first signal, the second signal, or both, in a time domain, a frequency domain, or both.

Aspect 24: The method of any of aspects 15 through 23, wherein the cell information comprises a cell identifier or a cell group identifier.

Aspect 25: The method of any of aspects 15 through 24, wherein both the first signal and the second signal are scrambled in accordance with the scrambling identifier.

Aspect 26: A UE for wireless communications, comprising one or more memories storing processor-executable code, and one or more processors coupled with the one or more memories and individually or collectively operable to execute the code to cause the UE to perform a method of any of aspects 1 through 14.

Aspect 27: A UE for wireless communications, comprising at least one means for performing a method of any of aspects 1 through 14.

Aspect 28: A non-transitory computer-readable medium storing code for wireless communications, the code comprising instructions executable by one or more processors to perform a method of any of aspects 1 through 14.

Aspect 29: A network entity for wireless communications, comprising one or more memories storing processor-executable code, and one or more processors coupled with the one or more memories and individually or collectively operable to execute the code to cause the network entity to perform a method of any of aspects 15 through 25.

Aspect 30: A network entity for wireless communications, comprising at least one means for performing a method of any of aspects 15 through 25.

Aspect 31: A non-transitory computer-readable medium storing code for wireless communications, the code comprising instructions executable by one or more processors to perform a method of any of aspects 15 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
monitor, over a bandwidth, for a frequency-modulated continuous wave (FMCW) signal associated with a cell, wherein the FMCW signal comprises a first signal that increases in frequency from a first frequency to a second frequency in a time interval and a second signal that decreases in frequency from the second frequency to the first frequency in the time interval, and wherein at least a portion of the first signal, the second signal, or both, is scrambled in accordance with a scrambling identifier;
identify, based at least in part on the FMCW signal, the scrambling identifier from a plurality of candidate scrambling identifiers, wherein the scrambling identifier is a function of cell information of the cell; and
communicate one or more messages with the cell based at least in part on the cell information.

2. The UE of claim 1, wherein the one or more processors are individually or collectively further operable to execute the code to cause the UE to:
receive an FMCW burst transmission comprising the FMCW signal and at least a second FMCW signal, wherein the second FMCW signal comprises a third signal that increases in frequency from a third frequency to a fourth frequency in a second time interval and a fourth signal that decreases in frequency from the fourth frequency to the third frequency in the second time interval.

3. The UE of claim 2, wherein a position of the FMCW signal in the FMCW burst transmission relative to the second FMCW signal indicates additional cell information of the cell.

4. The UE of claim 2, wherein the one or more processors are individually or collectively further operable to execute the code to cause the UE to:
receive configuration information indicating a position of the FMCW signal in the FMCW burst transmission.

5. The UE of claim 1, wherein the scrambling identifier is identified based at least in part on the scrambling identifier descrambling at least the portion of the first signal, the second signal, or both, of the FMCW signal.

6. The UE of claim 5, wherein the one or more processors are individually or collectively further operable to execute the code to cause the UE to:
receive configuration information indicating the plurality of candidate scrambling identifiers, wherein each of the plurality of candidate scrambling identifiers is applied to the FMCW signal in accordance with the configuration information.

7. The UE of claim 1, wherein a scrambling pattern or a location of the portion of the first signal, the second signal, or both, indicates additional cell information.

8. The UE of claim 1, wherein the scrambling identifier is identified based at least in part on a default scrambling pattern at the UE.

9. The UE of claim 1, wherein the one or more processors are individually or collectively further operable to execute the code to cause the UE to:
perform a cell search procedure within the bandwidth, wherein the FMCW signal is communicated at a raster frequency of a plurality of raster frequencies within the bandwidth; and
identify a raster location and the raster frequency associated with the cell based at least in part on reception of the FMCW signal at the raster frequency, wherein the one or more messages are communicated with the cell based at least in part on the raster frequency.

10. The UE of claim 1, wherein the one or more processors are individually or collectively further operable to execute the code to cause the UE to:
perform a radio frequency sensing operation associated with the UE based at least in part on the FMCW signal and the scrambling identifier.

11. The UE of claim 1, wherein the one or more processors are individually or collectively further operable to execute the code to cause the UE to:
communicate information associated with a position of the UE based at least in part on the FMCW signal and the scrambling identifier.

12. The UE of claim 1, wherein the cell information comprises a cell identifier or a cell group identifier.

13. The UE of claim 1, wherein both the first signal and the second signal are scrambled in accordance with the scrambling identifier.

14. The UE of claim 1, wherein the portion of the first signal, the second signal, or both, is scrambled in a time domain, a frequency domain, or both.

15. A network entity, comprising:
one or more memories storing processor-executable code; and
one or more processors coupled with the one or more memories and individually or collectively operable to execute the code to cause the network entity to:
output, over a bandwidth, a frequency-modulated continuous wave (FMCW) signal associated with a cell, the FMCW signal comprising a first signal that increases in frequency from a first frequency to a second frequency in a time interval and a second signal that decreases in frequency from the second frequency to the first frequency in the time interval, wherein at least a portion of the first signal, the second signal, or both, is scrambled in accordance with a scrambling identifier from a plurality of candidate scrambling identifiers, and wherein the scrambling identifier is a function of cell information of the cell; and
communicate one or more messages with a user equipment (UE) based at least in part on the cell information.

16. The network entity of claim 15, wherein the one or more processors are individually or collectively further operable to execute the code to cause the network entity to:
output an FMCW burst transmission comprising the FMCW signal and at least a second FMCW signal, wherein the second FMCW signal comprises a third signal that increases in frequency from a third frequency to a fourth frequency in a second time interval and a fourth signal that decreases in frequency from the fourth frequency to the third frequency in the second time interval.

17. The network entity of claim 16, wherein a position of the FMCW signal in the FMCW burst transmission relative to the second FMCW signal indicates additional cell information of the cell.

18. The network entity of claim 16, wherein the one or more processors are individually or collectively further operable to execute the code to cause the network entity to:
obtain configuration information indicating a position of the FMCW signal in the FMCW burst transmission.

19. The network entity of claim 15, wherein the one or more processors are individually or collectively further operable to execute the code to cause the network entity to:
obtain configuration information indicating the plurality of candidate scrambling identifiers, wherein the portion of the first signal, the second signal, or both, is scrambled in accordance with the configuration information.

20. The network entity of claim 15, wherein a scrambling pattern or a location of the portion of the first signal, the second signal, or both, indicates additional cell information of the cell.

21. The network entity of claim 15, wherein the one or more processors are individually or collectively further operable to execute the code to cause the network entity to:
obtain configuration information indicating a scrambling pattern or a position of the portion of the first signal, the second signal, or both, wherein the portion of the first signal, the second signal, or both, is scrambled based at least in part on the configuration information.

22. The network entity of claim 15, wherein:
the FMCW signal is output at a raster frequency of a plurality of raster frequencies within the bandwidth, and
the one or more messages are communicated with the UE based at least in part on the raster frequency.

23. The network entity of claim 15, wherein the one or more processors are individually or collectively further operable to execute the code to cause the network entity to:
scramble the portion of the first signal, the second signal, or both, in a time domain, a frequency domain, or both.

24. The network entity of claim 15, wherein the cell information comprises a cell identifier or a cell group identifier.

25. The network entity of claim 15, wherein both the first signal and the second signal are scrambled in accordance with the scrambling identifier.

26. A method for wireless communications at a user equipment (UE), comprising:
monitoring, over a bandwidth, for a frequency-modulated continuous wave (FMCW) signal associated with a cell, wherein the FMCW signal comprises a first signal that increases in frequency from a first frequency to a second frequency in a time interval and a second signal that decreases in frequency from the second frequency to the first frequency in the time interval, and wherein at least a portion of the first signal, the second signal, or both, is scrambled in accordance with a scrambling identifier;
identifying, based at least in part on the FMCW signal, the scrambling identifier from a plurality of candidate scrambling identifiers, wherein the scrambling identifier is a function of cell information of the cell; and
communicating one or more messages with the cell based at least in part on the cell information.

27. The method of claim 26, further comprising:
receiving an FMCW burst transmission comprising the FMCW signal and at least a second FMCW signal, wherein the second FMCW signal comprises a third signal that increases in frequency from a third frequency to a fourth frequency in a second time interval and a fourth signal that decreases in frequency from the fourth frequency to the third frequency in the second time interval.

28. The method of claim 26, wherein the scrambling identifier is identified based at least in part on the scrambling identifier descrambling at least the portion of the first signal, the second signal, or both, of the FMCW signal.

29. A method for wireless communications at a network entity, comprising:
outputting, over a bandwidth, a frequency-modulated continuous wave (FMCW) signal associated with a cell, the FMCW signal comprising a first signal that increases in frequency from a first frequency to a second frequency in a time interval and a second signal that decreases in frequency from the second frequency to the first frequency in the time interval, wherein at least a portion of the first signal, the second signal, or both, is scrambled in accordance with a scrambling identifier from a plurality of candidate scrambling identifiers, and wherein the scrambling identifier is a function of cell information of the cell; and
communicating one or more messages with a user equipment (UE) based at least in part on the cell information.

30. The method of claim 29, further comprising:
outputting an FMCW burst transmission comprising the FMCW signal and at least a second FMCW signal, wherein the second FMCW signal comprises a third signal that increases in frequency from a third frequency to a fourth frequency in a second time interval and a fourth signal that decreases in frequency from the fourth frequency to the third frequency in the second time interval.
